(19) United States
(12) Patent Application Publication
(10) Pub. No.: US 2026/0050228 A1
(43) Pub. Date: Feb. 19, 2026

(54) IMAGE FORMING APPARATUS

(71) Applicant: FUJIFILM Business Innovation Corp., Tokyo (JP)

(72) Inventors: Yuka KAWAMOTO, Kanagawa (JP); Yoshiteru YAMADA, Kanagawa (JP); Misaki KOMURA, Kanagawa (JP); Daisuke TANO, Kanagawa (JP)

(73) Assignee: FUJIFILM Business Innovation Corp., Tokyo (JP)

(21) Appl. No.: 19/043,536

(22) Filed: Feb. 3, 2025

(30) Foreign Application Priority Data
Aug. 19, 2024 (JP) 2024-137806

(51) Int. Cl. G03G 5/07; G03G 9/08; G03G 21/00

(52) U.S. Cl. CPC G03G 5/071; G03G 9/0819; G03G 21/0017; G03G 2215/00957; G03G 2215/00962; G03G 2215/0604

(57) ABSTRACT

An image forming apparatus includes a photoreceptor, a charging device that charges a surface of the photoreceptor, an electrostatic latent image forming device that forms an electrostatic latent image on the charged surface of the photoreceptor, a developing device that contains a developer containing a toner and develops the electrostatic latent image formed on the surface of the photoreceptor to form a toner image, a transfer device that transfers the toner image to a surface of a recording medium, and a cleaning device that has a cleaning blade coming into contact with the surface of the photoreceptor to clean the surface of the photoreceptor, in which the toner contains toner particles, titanate compound particles, and silica particles, a surface layer of the photoreceptor contains a polyarylate resin that has a dicarboxylic acid unit (A) represented by Formula (A) and a diol unit (B) represented by Formula (B), and the cleaning blade has a first polyurethane layer that is a layer coming into contact with the photoreceptor and has a hardness of 85 degrees or more and 95 degrees or less, and a second polyurethane layer that is a layer supporting the first polyurethane layer and has a hardness of 55 degrees or more and 70 degrees or less.

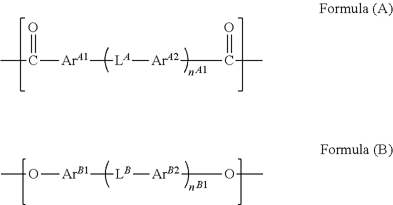

In Formula (A), Ar^{A1} and Ar^{A2} are each independently an aromatic ring which may have a substituent, L^{A} is a single bond or a divalent linking group, and n^{A1} is 0, 1, or 2.

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

### CROSS-REFERENCE TO RELATED APPLICATIONS

This application is based on and claims priority under 35 USC 119 from Japanese Patent Application No. 2024-137806 filed Aug. 19, 2024.

### BACKGROUND

### (i) Technical Field

The present disclosure relates to an image forming apparatus.

### (ii) Related Art

JP2023-143015A discloses an image forming apparatus including a photoreceptor that includes a lamination type photosensitive layer in which a charge generation layer and a charge transport layer are laminated in this order on a conductive support, in which the charge transport layer contains a charge transport material, a binder resin, and fluorine-based resin fine particles, a contact angle of a surface of the charge transport layer with respect to pure water is 850 or more, and a toner in which a core obtained by adding silica to strontium titanate is subjected to a hydrophobic treatment with a silane compound and is externally added with a strontium titanate fine powder and silica fine particles is used.

JP2021-071614A discloses an electrostatic charge image developing toner in which inorganic particles A and silica particles B are externally added, in which the inorganic particles A contain calcium titanate or barium titanate, a number-average primary particle diameter of the inorganic particles A is 40 nm to 80 nm, a number-average primary particle diameter of the silica particles B is 60 nm to 120 nm, and a circularity of the silica particles B is 0.95 to 1.00.

JP2020-187183A discloses an image forming apparatus including a toner in which, in a case where a virtual straight line connecting a contact point between an image holder and a cleaning member and a center O of the image holder in a cross-sectional view of the image holder is defined as a line segment X, an angle θ formed by the line segment X with respect to a horizontal plane Y is 0 degrees or more and 30 degrees or less, the image holder, and the cleaning member having a type A durometer hardness of 65 degrees or more and 80 degrees or less, in which the toner is externally added with titanate compound particles doped with a lanthanum and a Group 5 element of the periodic table.

### SUMMARY

An object of the present disclosure is to provide an image forming apparatus in which density unevenness is unlikely to occur in an image and filming is unlikely to occur on a surface of a photoreceptor.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects. Each formula is the same as the formula having the same number described later.

Aspects of non-limiting embodiments of the present disclosure relate to an image forming apparatus including:
a photoreceptor;
a charging device that charges a surface of the photoreceptor;
an electrostatic latent image forming device that forms an electrostatic latent image on the charged surface of the photoreceptor;
a developing device that contains a developer containing a toner and develops the electrostatic latent image formed on the surface of the photoreceptor to form a toner image;
a transfer device that transfers the toner image to a surface of a recording medium; and
a cleaning device that has a cleaning blade coming into contact with the surface of the photoreceptor to clean the surface of the photoreceptor,
in which the toner contains toner particles, titanate compound particles, and silica particles,
a surface layer of the photoreceptor contains a polyarylate resin that has a dicarboxylic acid unit (A) represented by Formula (A) and a diol unit (B) represented by Formula (B), and
the cleaning blade has a first polyurethane layer that is a layer coming into contact with the photoreceptor and has a hardness of 85 degrees or more and 95 degrees or less, and a second polyurethane layer that is a layer supporting the first polyurethane layer and has a hardness of 55 degrees or more and 70 degrees or less.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment;

FIG. 2 is a view schematically showing a configuration of another example of the image forming apparatus according to the present exemplary embodiment;

FIG. 3 is a partial cross-sectional view showing an example of a layer configuration of a photoreceptor according to the present exemplary embodiment;

FIG. 4 is a partial cross-sectional view showing another example of the layer configuration of the photoreceptor according to the present exemplary embodiment;

FIG. 5 is a schematic configuration view showing an example of a cleaning blade according to the present exemplary embodiment; and

FIG. 6 is a schematic configuration view showing an example of the cleaning blade according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, an alkyl group and an alkylene group are any of linear, branched, or cyclic, unless otherwise specified.

In the present disclosure, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, “(meth)acrylic” is an expression including both acrylic and methacrylic, and “(meth)acrylate” is an expression including both acrylate and methacrylate.

In the present disclosure, “constitutional unit” of a copolymer or a resin is the same as a monomer unit.

In the present disclosure, “photoreceptor” refers to “electrophotographic photoreceptor”.

In the present disclosure, “axial direction” of the photoreceptor means a direction in which a rotation axis of the photoreceptor extends, and “circumferential direction” of the photoreceptor means a rotation direction of the photoreceptor.

### Image Forming Apparatus

The image forming apparatus according to the present exemplary embodiment includes a photoreceptor, a charging device that charges a surface of the photoreceptor, an electrostatic latent image forming device that forms an electrostatic latent image on the charged surface of the photoreceptor, a developing device that contains a developer containing a toner and develops the electrostatic latent image formed on the surface of the photoreceptor to form a toner image, a transfer device that transfers the toner image to a surface of a recording medium, and a cleaning device that has a cleaning blade coming into contact with the surface of the photoreceptor to clean the surface of the photoreceptor.

In the image forming apparatus according to the present exemplary embodiment, the toner constituting the developer contained in the developing device contains toner particles, titanate compound particles, and silica particles, a surface layer of the photoreceptor contains a polyarylate resin that has a dicarboxylic acid unit (A) represented by Formula (A) and a diol unit (B) represented by Formula (B), and the cleaning blade has a first polyurethane layer that is a layer coming into contact with the photoreceptor and has a hardness of 85 degrees or more and 95 degrees or less, and a second polyurethane layer that is a layer supporting the first polyurethane layer and has a hardness of 55 degrees or more and 70 degrees or less.

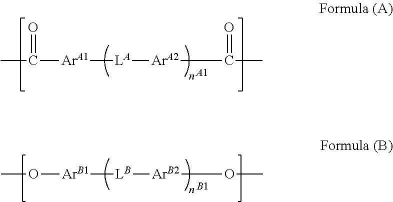

In Formula (A), Ar^{A1} and Ar^{A2} are each independently an aromatic ring which may have a substituent, L^{A} is a single bond or a divalent linking group, and n^{A1} is 0, 1, or 2.

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

In the present disclosure, the polyarylate resin having the dicarboxylic acid unit (A) represented by Formula (A) and the diol unit (B) represented by Formula (B) may be referred to as “polyarylate resin (S)”.

With the image forming apparatus according to the present exemplary embodiment, density unevenness is unlikely to occur in an image, and filming (formation of a coating film) is unlikely to occur on a surface of a photoreceptor.

In the related art, a toner in which titanate compound particles and silica particles are externally added has been known. The toner is less likely to cause occurrence of blurring and fogging (phenomenon in which the toner adheres to a portion of a photoreceptor where an electrostatic latent image is not present, and an unintended image appears on a recording medium). However, since the toner has a relatively small amount of the external additive transferred to the photoreceptor, a frictional force between the photoreceptor and a cleaning blade tends to increase. As a result, a difference in abrasion amount between an image area and a non-image area on the surface of the photoreceptor is increased, and density unevenness occurs. In addition, behavior of a tip of the cleaning blade is unstable, and cleaning properties are deteriorated. In a case where a hardness of the cleaning blade is increased in order to stabilize the behavior of the tip of the cleaning blade, the difference in abrasion amount between the image area and the non-image area on the surface of the photoreceptor is also increased.

On the other hand, in the image forming apparatus according to the present exemplary embodiment, the surface layer of the photoreceptor contains the polyarylate resin (S), and thus abrasion resistance is excellent. In the polyarylate resin (S), resin molecules are bonded to each other by an intermolecular force due to stacking of aromatic rings, and thus the abrasion resistance of the surface layer is improved.

In addition, in the image forming apparatus according to the present exemplary embodiment, the side of the cleaning blade that comes into contact with the photoreceptor is made to be a relatively hard layer (first polyurethane layer) and is supported by a relatively soft layer (second polyurethane layer), so that the behavior of the tip of the cleaning blade is stabilized and the cleaning properties are improved.

The first polyurethane layer of the cleaning blade is a polyurethane layer having a hardness of 85 degrees or more and 95 degrees or less.

In a case where the hardness of the first polyurethane layer is less than 85 degrees, the cleaning properties are deteriorated, and filming may occur on the surface of the photoreceptor. From the viewpoint of suppressing the occurrence of filming on the surface of the photoreceptor, the hardness of the first polyurethane layer is 85 degrees or more, and is, for example, preferably 86 degrees or more, more preferably 87 degrees or more, and still more preferably 88 degrees or more.

In a case where the hardness of the first polyurethane layer is more than 95 degrees, the difference in abrasion amount between the image area and the non-image area on the surface of the photoreceptor is increased, and thus the density unevenness may occur in the image. From the viewpoint of suppressing the occurrence of density unevenness in the image, the hardness of the first polyurethane layer is 95 degrees or less, and is, for example, preferably 94 degrees or less, more preferably 93 degrees or less, and still more preferably 92 degrees or less.

The second polyurethane layer of the cleaning blade is a polyurethane layer having a hardness of 55 degrees or more and 70 degrees or less.

In a case where the hardness of the second polyurethane layer is less than 55 degrees, the cleaning blade may be peeled off, the cleaning force may be decreased, and filming may occur on the surface of the photoreceptor. From the viewpoint of suppressing the occurrence of filming on the surface of the photoreceptor, the hardness of the second polyurethane layer is 55 degrees or more, and is, for example, preferably 58 degrees or more, more preferably 60 degrees or more, and still more preferably 62 degrees or more.

In a case where the hardness of the second polyurethane layer is more than 70 degrees, the difference in abrasion amount between the image area and the non-image area on the surface of the photoreceptor is increased, and thus the density unevenness may occur in the image. From the viewpoint of suppressing the occurrence of density unevenness in the image, the hardness of the second polyurethane layer is 70 degrees or less, and is, for example, preferably 69 degrees or less, more preferably 68 degrees or less, and still more preferably 67 degrees or less.

Hereinafter, a configuration of the image forming apparatus according to the present exemplary embodiment will be described in detail.

The image forming apparatus according to the present exemplary embodiment includes a photoreceptor, a charging device, an electrostatic latent image forming device, a developing device, a transfer device, and a photoreceptor cleaning device.

The image forming apparatus according to the present exemplary embodiment may further include a fixing device that fixes the toner image transferred to the surface of the recording medium, a static elimination device that removes charges by irradiating the surface of the photoreceptor after the transfer of the toner image and before the charging with charge removing light, and the like.

In the image forming apparatus according to the present exemplary embodiment, a portion including the photoreceptor may have a cartridge structure (process cartridge) that is attachable to and detachable from the image forming apparatus.

The image forming apparatus according to the present exemplary embodiment may be a direct transfer-type image forming apparatus that directly transfers a toner image formed on the surface of the photoreceptor to a recording medium; or an intermediate transfer-type image forming apparatus that primarily transfers the toner image formed on the surface of the photoreceptor to the surface of an intermediate transfer member and secondarily transfers the toner image transferred to the surface of the intermediate transfer member to the surface of the recording medium. In the intermediate transfer-type apparatus, the transfer device has an intermediate transfer member with surface on which the toner image will be transferred, a primary transfer device that performs primary transfer to transfer the toner image formed on the surface of the photoreceptor to the surface of the intermediate transfer member, and a secondary transfer device that performs secondary transfer to transfer the toner image transferred to the surface of the intermediate transfer member to the surface of a recording medium.

An example of the image forming apparatus according to the present exemplary embodiment will be shown below, but the present invention is not limited thereto. Among the parts shown in the drawing, main parts will be described, and others will not be described.

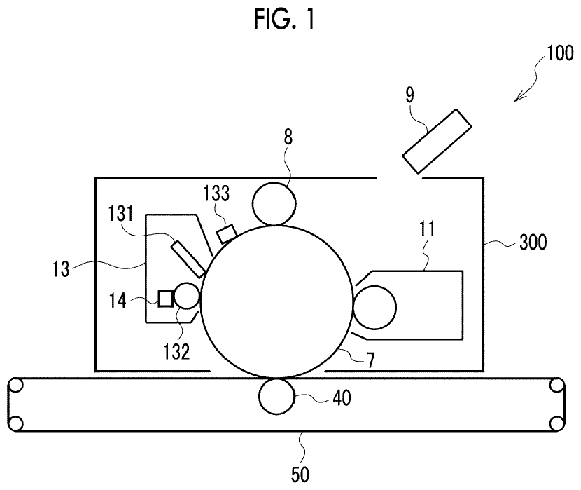

FIG. 1 is a view schematically showing a configuration of an example of the image forming apparatus according to the present exemplary embodiment.

As shown in FIG. 1, an image forming apparatus 100 according to the present exemplary embodiment includes a process cartridge 300 including a photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the photoreceptor 7 from an opening portion of the process cartridge 300; the transfer device 40 is disposed at a position that faces the photoreceptor 7 through the intermediate transfer member 50; and the intermediate transfer member 50 is disposed such that a part of the intermediate transfer member 50 is in contact with the photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 1 integrally supports the photoreceptor 7, a charging device 8 (an example of the charging device), a developing device 11 (an example of the developing device), and a cleaning device 13 (an example of the photoreceptor cleaning device) in a housing. The cleaning device 13 has a cleaning blade (an example of a cleaning member) 131, and the cleaning blade 131 is disposed to come into contact with the surface of the photoreceptor 7.

FIG. 1 shows an example of an image forming apparatus including a fibrous member 132 (roll shape) that supplies a lubricant 14 to the surface of the photoreceptor 7 and a fibrous member 133 (flat brush shape) that assists the cleaning, but these are disposed as necessary.

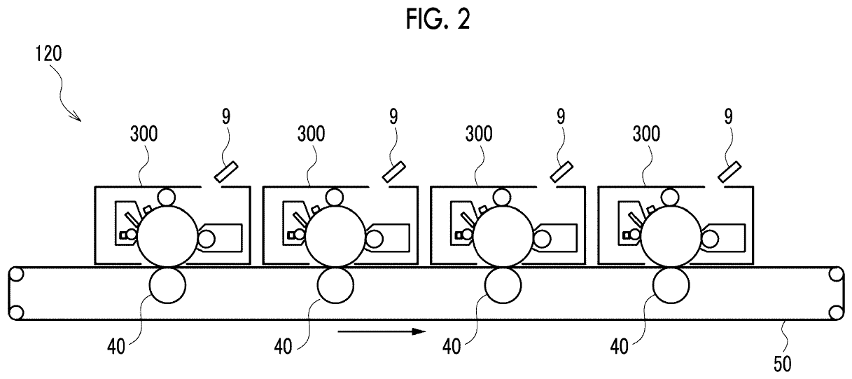

FIG. 2 is a view schematically showing a configuration of another example of the image forming apparatus according to the present exemplary embodiment.

An image forming apparatus 120 shown in FIG. 2 is a tandem type multicolor image forming apparatus in which four process cartridges 300 are mounted. The image forming apparatus 120 is formed such that the four process cartridges 300 are arranged in parallel on the intermediate transfer member 50, and one photoreceptor is used for each color. The image forming apparatus 120 has the same configuration as the image forming apparatus 100, except that the image forming apparatus 120 is of a tandem type.

Hereinafter, each configuration of the image forming apparatus according to the present exemplary embodiment will be described.

### Photoreceptor

For example, the photoreceptor 7 has a structure in which a photosensitive layer is disposed on a conductive substrate. The photosensitive layer may be a lamination-type photosensitive layer consisting of a charge generation layer and a charge transporting layer, or may be a single layer-type photosensitive layer. Details of the photoreceptor will be described later.

### Charging Device

As the charging device 8, for example, a contact-type charger formed of a conductive or semi-conductive charging roller, a charging brush, a charging film, a charging rubber blade, a charging tube, or the like is used. As the charging device 8, for example, a known charger such as a non-contact type roller charger, and a scorotron charger or a corotron charger using corona discharge is also used.

### Exposure Device

Examples of the exposure device 9 include an optical system device that exposes the surface of the photoreceptor 7 to light such as a semiconductor laser beam, LED light, and liquid crystal shutter light in a predetermined image pattern. A wavelength of the light source is set to be within a spectral sensitivity region of the photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. The developer may be magnetic or non-magnetic. Details of the toner and the developer will be described later.

### Cleaning Device

As the cleaning device 13, a cleaning blade-type device including the cleaning blade 131 is used. Details of the cleaning blade will be described later.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. As the form of the intermediate transfer member, a drum-like intermediate transfer member may be used in addition to the belt-like intermediate transfer member.

An operation of forming an image by the image forming apparatus 100 shown in FIG. 1 will be described.

The photoreceptor 7 rotates at a predetermined speed.

The charging device 8 charges the surface of the photoreceptor 7.

For example, a laser beam is emitted from the exposure device 9 to the charged surface of the photoreceptor 7, and an electrostatic latent image is formed on the surface of the photoreceptor 7.

The electrostatic latent image formed on the photoreceptor 7 moves to a developing position as the photoreceptor 7 rotates. At the developing position, the electrostatic latent image on the photoreceptor 7 is developed and visualized by the developing device 11 as a toner image. The toner image formed on the photoreceptor 7 moves to a primary transfer position as the photoreceptor 7 rotates. At the primary transfer position, a transfer bias is applied to the transfer device 40, an electrostatic force from the photoreceptor 7 toward the transfer device 40 acts on the toner image on the photoreceptor 7, and the toner image is transferred to the intermediate transfer member 50.

The intermediate transfer member 50 travels at a predetermined speed, and the toner image is transferred to the recording medium by the secondary transfer device at a secondary transfer position.

The toner remaining on the surface of the photoreceptor 7 is removed and collected by the cleaning device 13.

Hereinafter, the configuration of the photoreceptor included in the image forming apparatus according to the present exemplary embodiment will be described in detail. In addition, the cleaning blade of the photoreceptor cleaning device included in the image forming apparatus according to the present exemplary embodiment will be described in detail. In addition, the toner and the developer used in the developing device included in the image forming apparatus according to the present exemplary embodiment will be described in detail.

### Photoreceptor

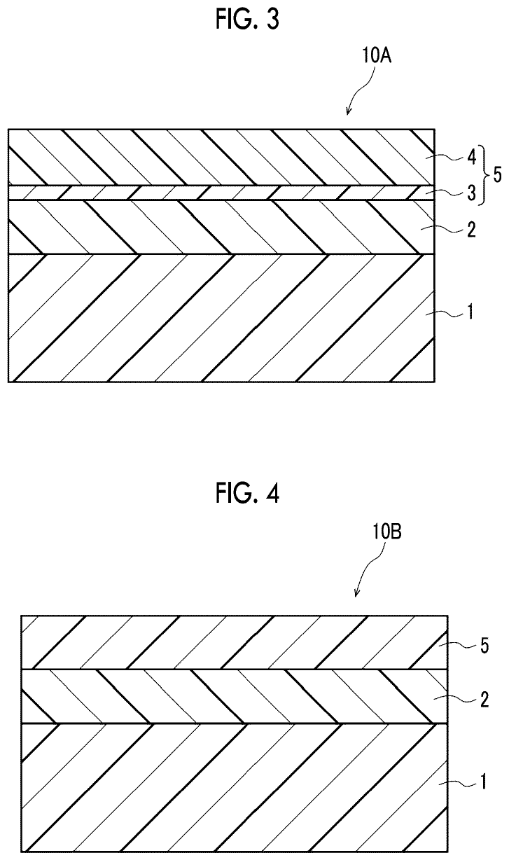

An exemplary embodiment of the photoreceptor will be described with reference to FIGS. 3 and 4.

FIG. 3 is a partial cross-sectional view schematically showing an example of a layer configuration of the photoreceptor. A photoreceptor 10A shown in FIG. 3 includes a lamination-type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation-type photosensitive layer). The photoreceptor 10A may include an interlayer (not shown) between the undercoat layer 2 and the charge generation layer 3. The undercoat layer 2 may or may not be provided.

In the photoreceptor 10A, the charge transport layer 4 is the surface layer.

FIG. 4 is a partial cross-sectional view schematically showing another example of the layer configuration of the photoreceptor. A photoreceptor 10B shown in FIG. 4 includes a single layer-type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5. The undercoat layer 2 may or may not be provided.

In the photoreceptor 10B, the photosensitive layer 5 is the surface layer.

In the image forming apparatus according to the present exemplary embodiment, the surface layer of the photoreceptor contains the polyarylate resin (S). In the polyarylate resin (S), resin molecules are bonded to each other by an intermolecular force due to stacking of aromatic rings, and thus the abrasion resistance of the surface layer is improved.

### Polyarylate Resin (S)

The surface layer of the photoreceptor contains, as a binder resin, a polyarylate resin (S) having at least a dicarboxylic acid unit (A) and a diol unit (B). The polyarylate resin (S) may have other dicarboxylic acid units in addition to the dicarboxylic acid unit (A). The polyarylate resin (S) may have other diol units in addition to the diol unit (B).

The dicarboxylic acid unit (A) is a constitutional unit represented by Formula (A).

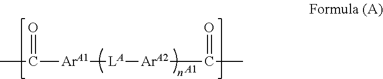

In Formula (A), Ar^{A1} and Ar^{A2} are each independently an aromatic ring which may have a substituent, L^{A} is a single bond or a divalent linking group, and n^{A1} is 0, 1, or 2.

The aromatic ring as Ar^{A1} may be a monocycle or a polycycle. Examples of the aromatic ring include a benzene ring, a naphthalene ring, an anthracene ring, and a phenanthrene ring; and for example, a benzene ring or a naphthalene ring is preferable.

A hydrogen atom on the aromatic ring as Ar^{A1} may be substituted with an alkyl group, an aryl group, an aralkyl group, an alkoxy group, an aryloxy group, a halogen atom, or the like. As the substituent in a case where the aromatic ring as Ar^{A1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{A2} may be a monocycle or a polycycle. Examples of the aromatic ring include a benzene ring, a naphthalene ring, an anthracene ring, and a phenanthrene ring; and for example, a benzene ring or a naphthalene ring is preferable.

A hydrogen atom on the aromatic ring as Ar^{A2} may be substituted with an alkyl group, an aryl group, an aralkyl group, an alkoxy group, an aryloxy group, a halogen atom, or the like. As the substituent in a case where the aromatic ring as Ar^{A2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

In a case where L^{A} is a divalent linking group, examples of the divalent linking group include an oxygen atom, a sulfur atom, and —C(Ra¹)(Ra²)—. Here, Ra¹ and Ra² are each independently a hydrogen atom, an alkyl group having 1 or more and 10 or less carbon atoms, an aryl group having 6 or more and 12 or less carbon atoms, or an aralkyl group having 7 or more and 20 or less carbon atoms, and Ra¹ and Ra² may be bonded to each other to form a cyclic alkyl group.

The alkyl group having 1 or more and 10 or less carbon atoms, as Ra¹ and Ra², may be linear, branched, or cyclic. The number of carbon atoms in the alkyl group is, for example, preferably 1 or more and 6 or less, more preferably 1 or more and 4 or less, and still more preferably 1 or 2.

The aryl group having 6 or more and 12 or less carbon atoms, as Ra¹ and Ra², may be a monocycle or a polycycle. The number of carbon atoms in the aryl group is, for example, preferably 6 or more and 10 or less, and more preferably 6.

An alkyl group of the aralkyl group having 7 or more and 20 or less carbon atoms, as Ra¹ and Ra², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Ra¹ and Ra², may be a monocycle or a polycycle. The number of carbon atoms in the aryl group is, for example, preferably 6 or more and 10 or less, and more preferably 6.

For example, it is preferable that the dicarboxylic acid unit (A) includes at least one selected from the group consisting of a dicarboxylic acid unit (A1) represented by Formula (A1), a dicarboxylic acid unit (A2) represented by Formula (A2), and a dicarboxylic acid unit (A3) represented by Formula (A3). For example, the dicarboxylic acid unit (A) more preferably includes at least one selected from the group consisting of the dicarboxylic acid unit (A1) and the dicarboxylic acid unit (A2), and still more preferably includes the dicarboxylic acid unit (A1).

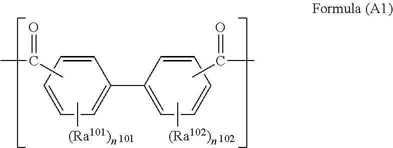

In Formula (A1), n¹⁰¹ and n¹⁰² are each independently an integer of 0 or more and 4 or less, and n¹⁰¹ pieces of Ra¹⁰¹'s and n¹⁰² pieces of Ra¹⁰²'s are each independently an alkyl group having 1 or more and 10 or less carbon atoms, an aryl group having 6 or more and 12 or less carbon atoms, or an alkoxy group having 1 or more and 6 or less carbon atoms.

n¹⁰¹ is, for example, preferably 0, 1, or 2, more preferably 0 or 1, and still more preferably 0.

n¹⁰² is, for example, preferably 0, 1, or 2, more preferably 0 or 1, and still more preferably 0.

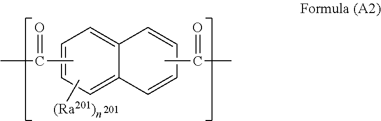

In Formula (A2), n²⁰¹ is an integer of 0 or more and 6 or less, and n²⁰¹ pieces of Ra²⁰¹'s are each independently an alkyl group having 1 or more and 10 or less carbon atoms, an aryl group having 6 or more and 12 or less carbon atoms, or an alkoxy group having 1 or more and 6 or less carbon atoms.

n²⁰¹ is, for example, preferably an integer of 0 or more and 4 or less, more preferably 0, 1, or 2, and still more preferably 0.

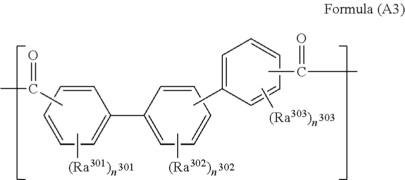

In Formula (A3), n³⁰¹, n³⁰², and n³⁰³ are each independently an integer of 0 or more and 4 or less, and n³⁰¹ pieces of Ra³⁰¹'s, n³⁰² pieces of Ra³⁰²'s, and n³⁰³ pieces of Ra³⁰³'s are each independently an alkyl group having 1 or more and 10 or less carbon atoms, an aryl group having 6 or more and 12 or less carbon atoms, or an alkoxy group having 1 or more and 6 or less carbon atoms.

n³⁰¹ is, for example, preferably 0, 1, or 2, more preferably 0 or 1, and still more preferably 0.

n³⁰² is, for example, preferably 0, 1, or 2, more preferably 0 or 1, and still more preferably 0.

n³⁰³ is, for example, preferably 0, 1, or 2, more preferably 0 or 1, and still more preferably 0.

Specific aspects and preferred aspects of Ra¹⁰¹ and Ra¹⁰² in Formula (A1), Ra²⁰¹ in Formula (A2), and Ra³⁰¹, Ra³⁰², and Ra³⁰³ in Formula (A3) are the same as each other, so that Ra¹⁰¹, Ra¹⁰², Ra²⁰¹, Ra³⁰¹, Ra³⁰², and Ra³⁰³ will be collectively referred to as “Ra”.

The alkyl group having 1 or more and 10 or less carbon atoms, as Ra, may be linear, branched, or cyclic. The number of carbon atoms in the alkyl group is, for example, preferably 1 or more and 6 or less, more preferably 1 or more and 4 or less, and still more preferably 1 or 2.

Examples of the linear alkyl group having 1 or more and 10 or less carbon atoms include a methyl group, an ethyl group, a n-propyl group, a n-butyl group, a n-pentyl group, a n-hexyl group, a n-heptyl group, a n-octyl group, a n-nonyl group, and a n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and a polycyclic (for example, bicyclic, tricyclic, or spirocyclic) alkyl group composed of these monocyclic alkyl groups linked to each other.

The aryl group having 6 or more and 12 or less carbon atoms, as Ra, may be a monocycle or a polycycle. The number of carbon atoms in the aryl group is, for example, preferably 6 or more and 10 or less, and more preferably 6.

Examples of the aryl group having 6 or more and 12 or less carbon atoms include a phenyl group, a biphenyl group, a 1-naphthyl group, and a 2-naphthyl group.

An alkyl group of the alkoxy group having 1 or more and 6 or less carbon atoms, as Ra, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Dicarboxylic acid units (A1-1) to (A1-3) are shown below as specific examples of the dicarboxylic acid unit (A1). The dicarboxylic acid unit (A1) is not limited thereto.

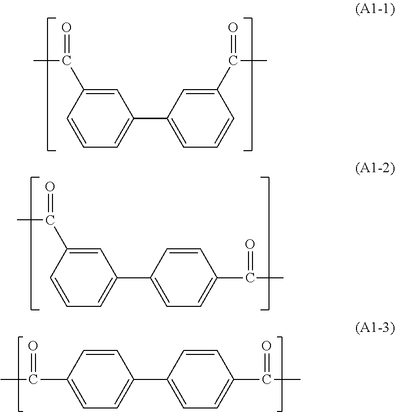

Dicarboxylic acid units (A2-1) to (A2-3) are shown below as specific examples of the dicarboxylic acid unit (A2). The dicarboxylic acid unit (A2) is not limited thereto.

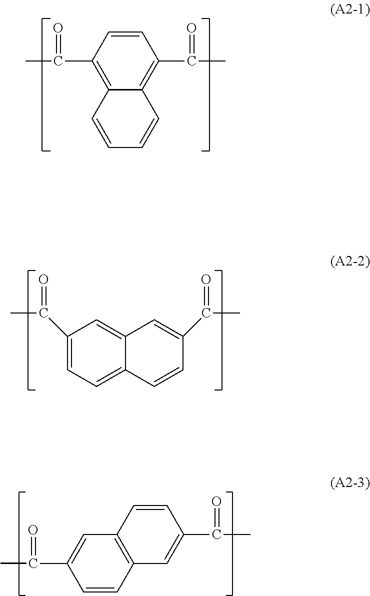

Dicarboxylic acid units (A3-1) to (A3-4) are shown below as specific examples of the dicarboxylic acid unit (A3). The dicarboxylic acid unit (A3) is not limited thereto.

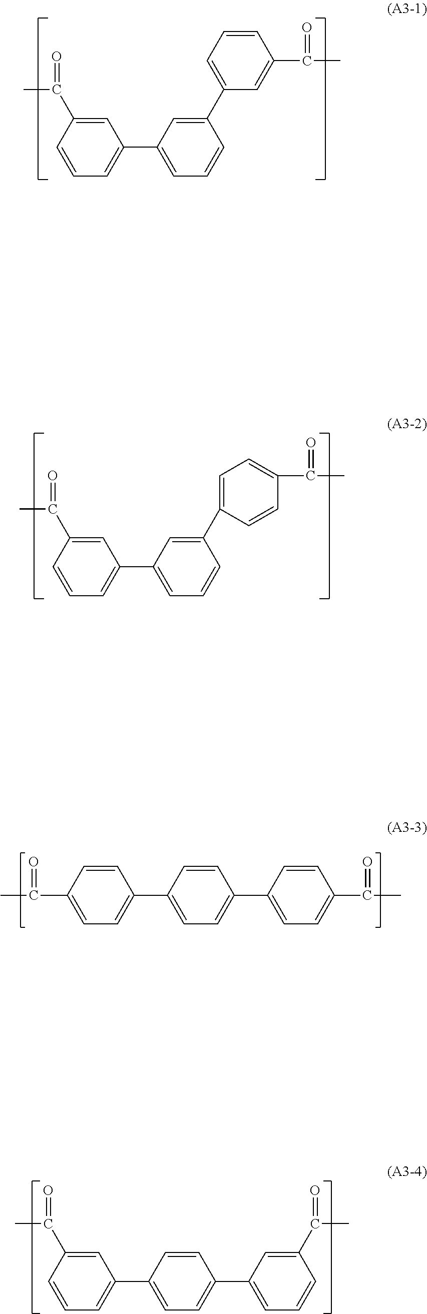

In the above-described specific examples, for example, the polyarylate resin (S) preferably has at least one selected from the group consisting of (A1-3), (A2-3), and (A3-3), more preferably has at least one selected from the group consisting of (A1-3) and (A2-3), and still more preferably at least (A1-3) as the dicarboxylic acid unit (A).

The dicarboxylic acid units (A1) to (A3) included in the polyarylate resin (S) may be used alone or in combination of two or more kinds thereof.

The total mass proportion of the dicarboxylic acid units (A1) to (A3) in the polyarylate resin (S) is, for example, preferably 15% by mass or more and 60% by mass or less.

In a case where the total mass proportion of the dicarboxylic acid units (A1) to (A3) is 15% by mass or more, the abrasion resistance of the surface layer is enhanced. From the viewpoint, the total mass proportion of the dicarboxylic acid units (A1) to (A3) is, for example, more preferably 20% by mass or more, and still more preferably 25% by mass or more.

In a case where the total mass proportion of the dicarboxylic acid units (A1) to (A3) is 60% by mass or less, peeling of the surface layer can be suppressed. From the viewpoint, the total mass proportion of the dicarboxylic acid units (A1) to (A3) is, for example, more preferably 55% by mass or less, and still more preferably 50% by mass or less.

The dicarboxylic acid unit (A) included in the polyarylate resin (S) may be used alone or in combination of two or more kinds thereof.

The polyarylate resin (S) may have other dicarboxylic acid units in addition to the dicarboxylic acid unit (A). Examples of other dicarboxylic acid units include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower alkyl ester units (for example, having 1 or more and 5 or less carbon atoms) thereof. The dicarboxylic acid units included in the polyarylate resin (S) may be used alone or in combination of two or more kinds thereof.

The diol unit (B) is a constitutional unit represented by Formula (B).

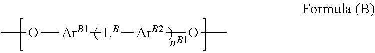

In Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The aromatic ring as Ar^{B1} may be a monocycle or a polycycle. Examples of the aromatic ring include a benzene ring, a naphthalene ring, an anthracene ring, and a phenanthrene ring; and for example, a benzene ring or a naphthalene ring is preferable.

A hydrogen atom on the aromatic ring as Ar^{B1} may be substituted with an alkyl group, an aryl group, an aralkyl group, an alkoxy group, an aryloxy group, a halogen atom, or the like. As the substituent in a case where the aromatic ring as Ar^{B1} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The aromatic ring as Ar^{B2} may be a monocycle or a polycycle. Examples of the aromatic ring include a benzene ring, a naphthalene ring, an anthracene ring, and a phenanthrene ring; and for example, a benzene ring or a naphthalene ring is preferable.

A hydrogen atom on the aromatic ring as Ar^{B2} may be substituted with an alkyl group, an aryl group, an aralkyl group, an alkoxy group, an aryloxy group, a halogen atom, or the like. As the substituent in a case where the aromatic ring as Ar^{B2} is substituted, for example, an alkyl group having 1 or more and 10 or less carbon atoms, an aryl group having 6 or more and 12 or less carbon atoms, or an alkoxy group having 1 or more and 6 or less carbon atoms is preferable.

The alkyl group having 1 or more and 20 or less carbon atoms, as Rb¹ and Rb², may be linear, branched, or cyclic. The number of carbon atoms in the alkyl group is, for example, preferably 1 or more and 18 or less, more preferably 1 or more and 14 or less, and still more preferably 1 or more and 10 or less.

The aryl group having 6 or more and 12 or less carbon atoms, as Rb¹ and Rb², may be a monocycle or a polycycle. The number of carbon atoms in the aryl group is, for example, preferably 6 or more and 10 or less, and more preferably 6.

An alkyl group of the aralkyl group having 7 or more and 20 or less carbon atoms, as Rb¹ and Rb², may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2.

An aryl group of the aralkyl group having 7 or more and 20 or less carbon atoms, as Rb¹ and Rb², may be a monocycle or a polycycle. The number of carbon atoms in the aryl group is, for example, preferably 6 or more and 10 or less, and more preferably 6.

For example, it is preferable that the diol unit (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

For example, the diol unit (B) more preferably includes at least one selected from the group consisting of the diol unit (B1) represented by Formula (B1), the diol unit (B2) represented by Formula (B2), the diol unit (B4) represented by Formula (B4), the diol unit (B5) represented by Formula (B5), and the diol unit (B6) represented by Formula (B6);
still more preferably includes at least one selected from the group consisting of the diol unit (B1) represented by Formula (B1), the diol unit (B2) represented by Formula (B2), the diol unit (B5) represented by Formula (B5), and the diol unit (B6) represented by Formula (B6);
even more preferably at least one selected from the group consisting of the diol unit (B1) represented by Formula (B1), the diol unit (B2) represented by Formula (B2), and the diol unit (B6) represented by Formula (B6); and
most preferably at least one selected from the group consisting of the diol unit (B1) represented by Formula (B1) and the diol unit (B2) represented by Formula (B2).

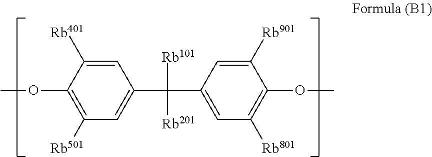

In Formula (B1), Rb¹¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom.

The number of carbon atoms in the branched alkyl group having 4 or more and 20 or less carbon atoms, as Rb¹⁰¹, is, for example, preferably 4 or more and 16 or less, more preferably 4 or more and 12 or less, and still more preferably 4 or more and 8 or less. Specific examples of Rb¹⁰¹ include an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

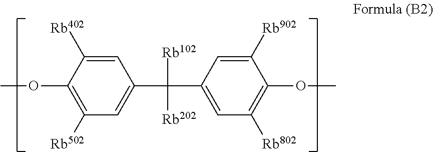

In Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 4 or more and 20 or less carbon atoms, as Rb¹⁰², is, for example, preferably 4 or more and 16 or less, more preferably 4 or more and 12 or less, and still more preferably 4 or more and 8 or less. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

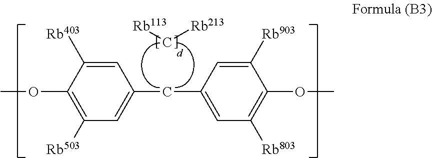

In Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or more and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹³ and Rb²¹³, is, for example, preferably 1 or 2 and more preferably 1. Specific examples of such a group include a methyl group, an ethyl group, and an n-propyl group.

An alkyl group of the alkoxy group having 1 or more and 4 or less carbon atoms, as Rb¹¹³ and Rb²¹³, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

Examples of the halogen atom as Rb¹¹³ and Rb²¹³ include a fluorine atom, a chlorine atom, a bromine atom, and an iodine atom.

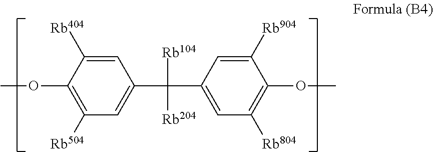

In Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom.

The alkyl group having 1 or more and 3 or less carbon atoms, as Rb¹⁰⁴, may be linear, branched, or cyclic. The number of carbon atoms in the alkyl group is, for example, preferably 1 or 2 and more preferably 1. Specific examples of Rb¹⁰⁴ include a methyl group, an ethyl group, an n-propyl group, an isopropyl group, and a cyclopropyl group.

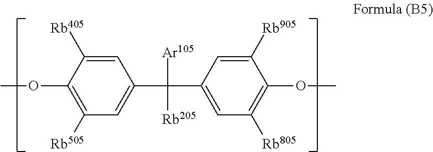

In Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom.

The aryl group having 6 or more and 12 or less carbon atoms, as Ar¹⁰⁵, may be a monocycle or a polycycle. The number of carbon atoms in the aryl group is, for example, preferably 6 or more and 10 or less, and more preferably 6.

An alkyl group of the aralkyl group having 7 or more and 20 or less carbon atoms, as Ar¹⁰⁵, may be linear, branched, or cyclic. The number of carbon atoms in the alkyl group of the aralkyl group having 7 or more and 20 or less carbon atoms is, for example, preferably 1 or more and 4 or less, more preferably 1 or more and 3 or less, and still more preferably 1 or 2. An aryl group of the aralkyl group having 7 or more and 20 or less carbon atoms, as Ar¹⁰⁵ may be a monocycle or a polycycle. The number of carbon atoms in the aryl group is, for example, preferably 6 or more and 10 or less, and more preferably 6. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

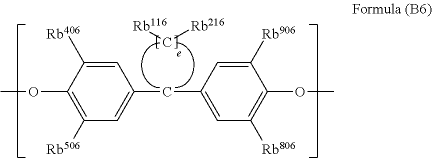

In Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom.

The number of carbon atoms in the linear alkyl group having 1 or more and 3 or less carbon atoms, as Rb¹¹⁶ and Rb²¹⁶, is, for example, preferably 1 or 2 and more preferably 1. Specific examples of such a group include a methyl group, an ethyl group, and an n-propyl group.

An alkyl group of the alkoxy group having 1 or more and 4 or less carbon atoms, as Rb¹¹⁶ and Rb²¹⁶, may be linear, branched, or cyclic. The number of carbon atoms in the alkyl group of the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

Examples of the halogen atom as Rb¹¹⁶ and Rb²¹⁶ include a fluorine atom, a chlorine atom, a bromine atom, and an iodine atom.

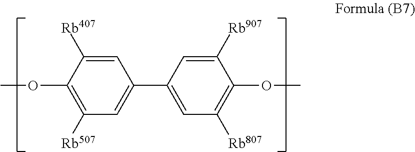

In Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom.

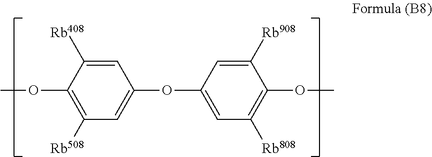

In Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.

Specific aspects and preferred aspects of Rb²⁰¹ in Formula (B1), Rb²⁰² in Formula (B2), Rb²⁰⁴ in Formula (B4), and Rb²⁰⁵ in Formula (B5) are the same as each other, so that Rb²⁰¹, Rb²⁰², Rb²⁰⁴, and Rb²⁰⁵ will be collectively referred to as “Rb²⁰⁰”.

The alkyl group having 1 or more and 3 or less carbon atoms, as Rb²⁰⁰, may be linear, branched, or cyclic. The number of carbon atoms in the alkyl group is, for example, preferably 1 or 2 and more preferably 1.

Examples of the alkyl group having 1 or more and 3 or less carbon atoms include a methyl group, an ethyl group, an n-propyl group, an isopropyl group, and a cyclopropyl group.

Specific aspects and preferred aspects of Rb⁴⁰¹ in Formula (B1), Rb⁴⁰² in Formula (B2), Rb⁴⁰³ in Formula (B3), Rb⁴⁰⁴ in Formula (B4), Rb⁴⁰⁵ in Formula (B5), Rb⁴⁰⁶ in Formula (B6), Rb⁴⁰⁷ in Formula (B7), and Rb⁴⁰⁸ in Formula (B8) are the same as each other, so that Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively referred to as “Rb⁴⁰⁰”.

The alkyl group having 1 or more and 4 or less carbon atoms, as Rb⁴⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁴⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁴⁰⁰ include a fluorine atom, a chlorine atom, a bromine atom, and an iodine atom.

Specific aspects and preferred aspects of Rb⁵⁰¹ in Formula (B1), Rb⁵⁰² in Formula (B2), Rb⁵⁰³ in Formula (B3), Rb⁵⁰⁴ in Formula (B4), Rb⁵⁰⁵ in Formula (B5), Rb⁵⁰⁶ in Formula (B6), Rb⁵⁰⁷ in Formula (B7), and Rb⁵⁰⁸ in Formula (B8) are the same as each other, so that Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively referred to as “Rb⁵⁰⁰”.

The alkyl group having 1 or more and 4 or less carbon atoms, as Rb⁵⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁵⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁵⁰⁰ include a fluorine atom, a chlorine atom, a bromine atom, and an iodine atom.

Specific aspects and preferred aspects of Rb⁸⁰¹ in Formula (B1), Rb⁸⁰² in Formula (B2), Rb⁸⁰³ in Formula (B3), Rb⁸⁰⁴ in Formula (B4), Rb⁸⁰⁵ in Formula (B5), Rb⁸⁰⁶ in Formula (B6), Rb⁸⁰⁷ in Formula (B7), and Rb⁸⁰⁸ in Formula (B8) are the same as each other, so that Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively referred to as “Rb⁸⁰⁰”.

The alkyl group having 1 or more and 4 or less carbon atoms, as Rb⁸⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁸⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁸⁰⁰ include a fluorine atom, a chlorine atom, a bromine atom, and an iodine atom.

Specific aspects and preferred aspects of Rb⁹⁰¹ in Formula (B1), Rb⁹⁰² in Formula (B2), Rb⁹⁰³ in Formula (B3), Rb⁹⁰⁴ in Formula (B4), Rb⁹⁰⁵ in Formula (B5), Rb⁹⁰⁶ in Formula (B6), Rb⁹⁰⁷ in Formula (B7), and Rb⁹⁰⁸ in Formula (B8) are the same as each other, so that Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively referred to as “Rb⁹⁰⁰”.

The alkyl group having 1 or more and 4 or less carbon atoms, as Rb⁹⁰⁰, may be linear, branched, or cyclic. The number of carbon atoms in the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

An alkyl group of the alkoxy group having 1 or more and 6 or less carbon atoms, as Rb⁹⁰⁰, may be linear, branched, or cyclic. The number of carbon atoms in the alkyl group of the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁹⁰⁰ include a fluorine atom, a chlorine atom, a bromine atom, and an iodine atom.

Diol units (B1-1) to (B1-6) are shown below as specific examples of the diol unit (B1). The diol unit (B1) is not limited thereto.

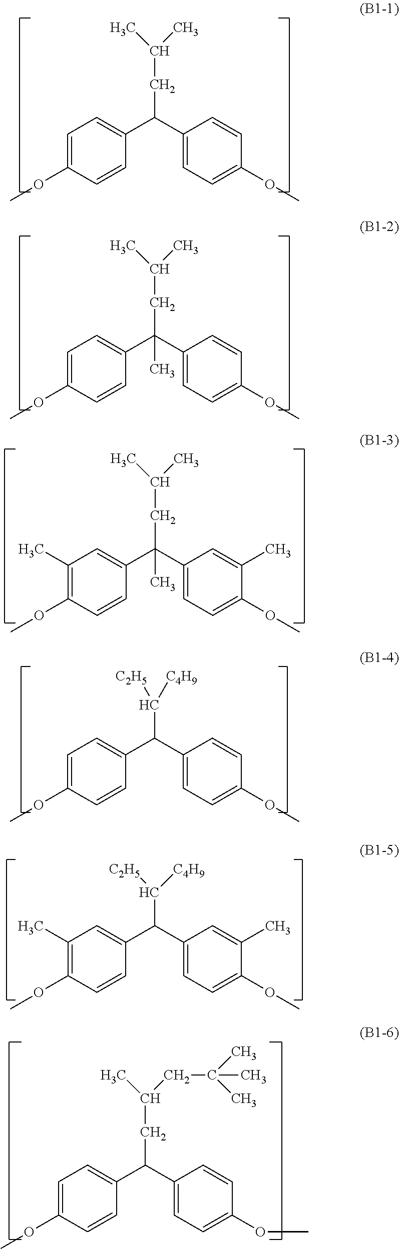

Diol units (B2-1) to (B2-11) are shown below as specific examples of the diol unit (B2). The diol unit (B2) is not limited thereto.

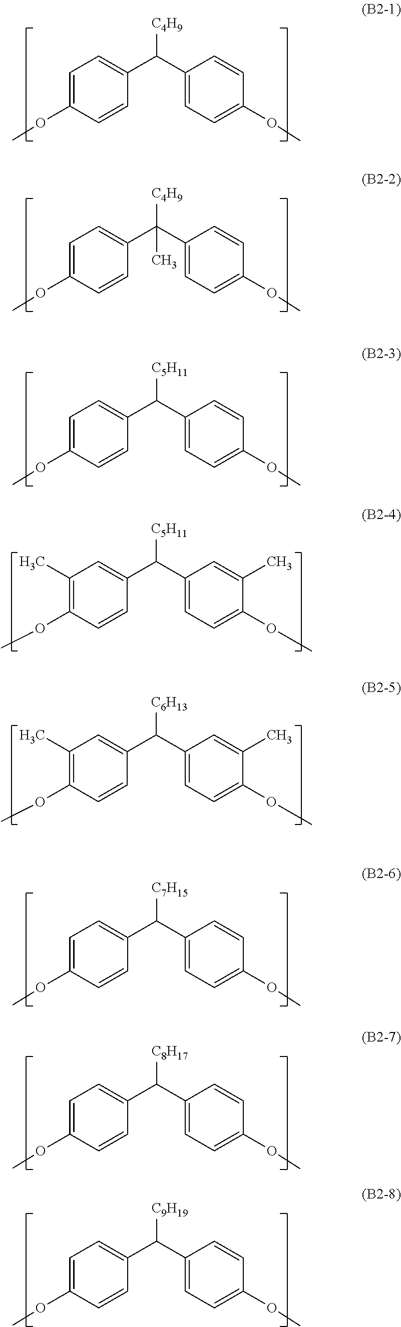

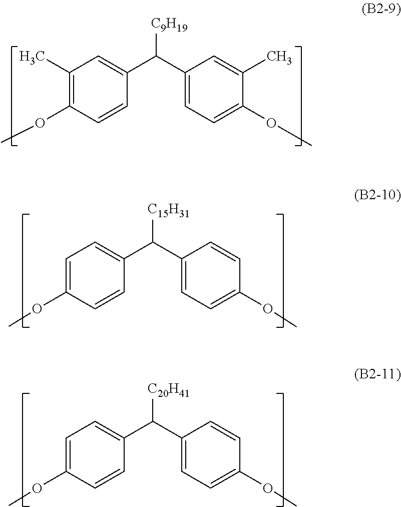

Diol units (B3-1) to (B3-4) are shown below as specific examples of the diol unit (B3). The diol unit (B3) is not limited thereto.

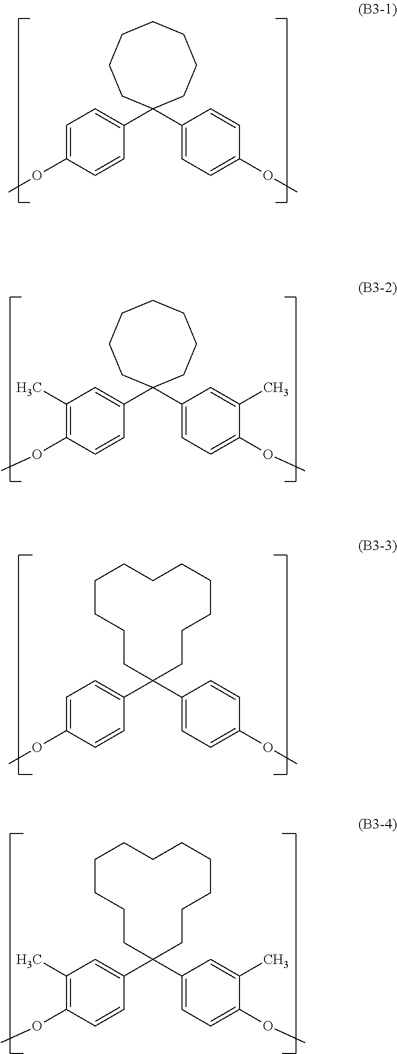

Diol units (B4-1) to (B4-7) are shown below as specific examples of the diol unit (B4). The diol unit (B4) is not limited thereto.

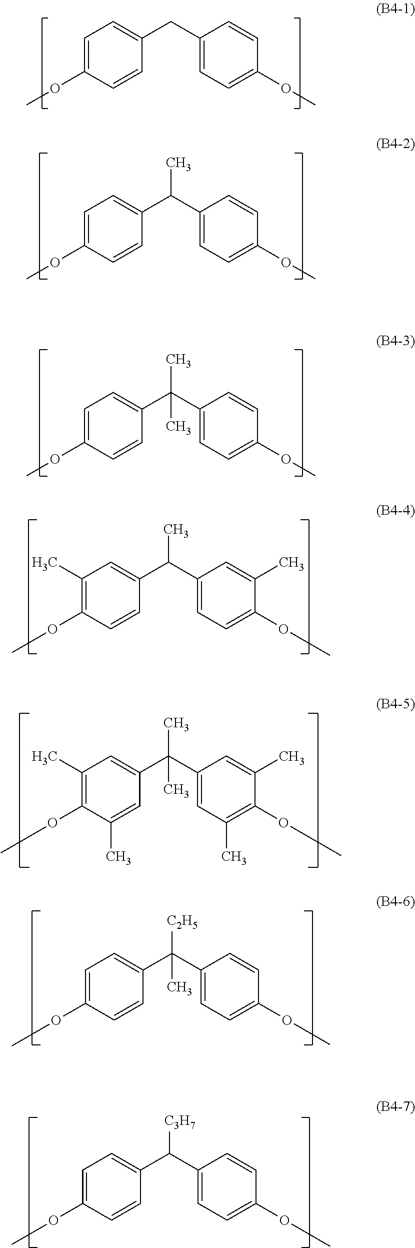

Diol units (B5-1) to (B5-6) are shown below as specific examples of the diol unit (B5). The diol unit (B5) is not limited thereto.

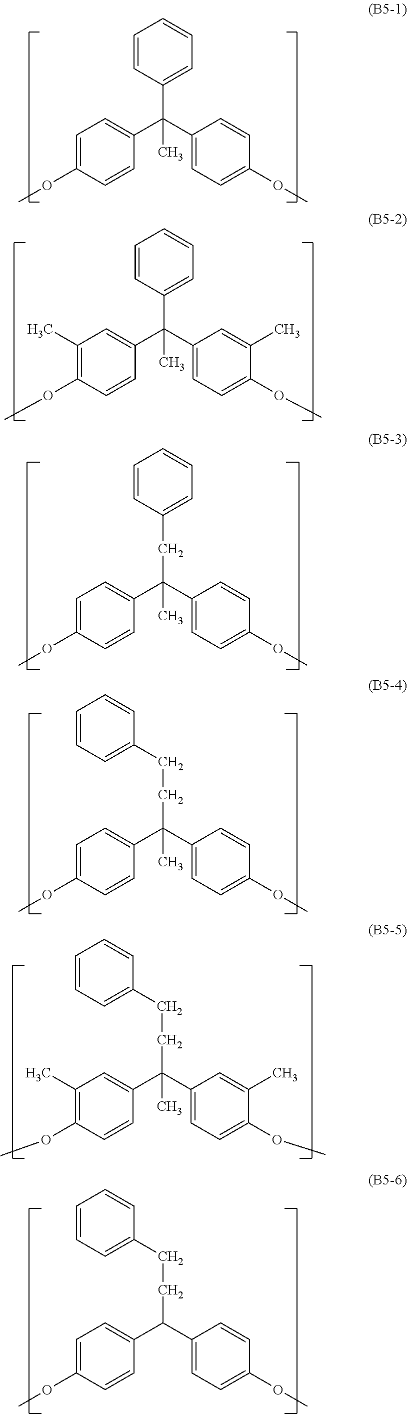

Diol units (B6-1) to (B6-4) are shown below as specific examples of the diol unit (B6). The diol unit (B6) is not limited thereto.

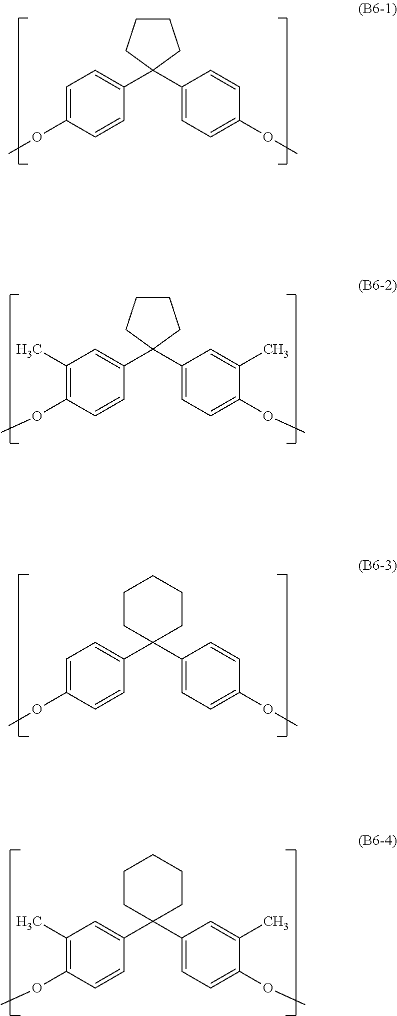

Diol units (B7-1) to (B7-3) are shown below as specific examples of the diol unit (B7). The diol unit (B7) is not limited thereto.

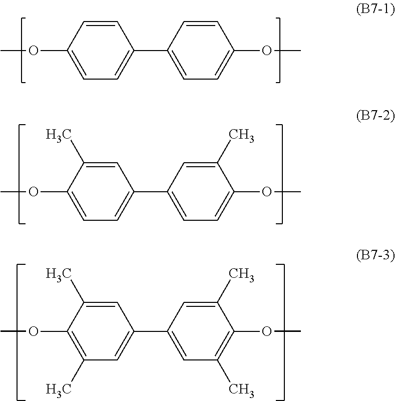

Diol units (B8-1) to (B8-3) are shown below as specific examples of the diol unit (B8). The diol unit (B8) is not limited thereto.

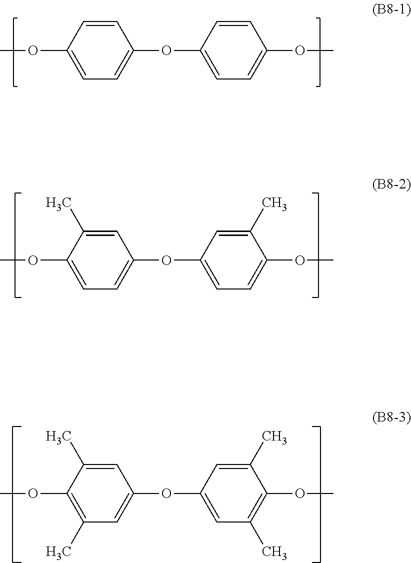

The diol unit (B) included in the polyarylate resin (S) may be used alone or in combination of two or more kinds thereof.

A mass proportion of the diol unit (B) in the polyarylate resin (S) is, for example, preferably 25% by mass or more and 80% by mass or less.

In a case where the mass proportion of the diol unit (B) is 25% by mass or more, peeling of the surface layer can be further suppressed. From the viewpoint, the mass proportion of the diol unit (B) is, for example, more preferably 30% by mass or more, and still more preferably 35% by mass or more.

In a case where the mass proportion of the diol unit (B) is 80% by mass or less, solubility in a coating solution for forming the surface layer is maintained, and thus the abrasion resistance can be improved. From the viewpoint, the mass proportion of the diol unit (B) is, for example, more preferably 75% by mass or less, and still more preferably 70% by mass or less.

Examples of other diol units in addition to the diol unit (B) include aliphatic diol (such as ethylene glycol, diethylene glycol, triethylene glycol, propylene glycol, butanediol, hexanediol, and neopentyl glycol) units, and alicyclic diol (such as cyclohexanediol, cyclohexanedimethanol, and hydrogenated bisphenol A) units. The diol units included in the polyarylate resin (S) may be used alone or in combination of two or more kinds thereof.

A terminal of the polyarylate resin (S) may be sealed or modified with a terminal-sealing agent, a molecular weight modifier, or the like used in a case of the production. Examples of the terminal-sealing agent or the molecular weight modifier include monohydric phenol, monovalent acid chloride, monohydric alcohol, and monovalent carboxylic acid.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of the monovalent acid chloride include monofunctional acid halides such as benzoyl chloride, benzoic acid chloride, methanesulfonyl chloride, phenylchloroformate, acetic acid chloride, butyric acid chloride, octyl acid chloride, benzenesulfonyl chloride, benzenesulfinyl chloride, sulfinyl chloride, benzene phosphonyl chloride, and substituents thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monovalent carboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

From the viewpoint of abrasion resistance of the surface of the photoreceptor, a weight-average molecular weight of the polyarylate resin (S) is, for example, preferably 80,000 or more, more preferably 90,000 or more, and still more preferably 100,000 or more.

From the viewpoint of suppressing the occurrence of filming on the surface of the photoreceptor by appropriately scraping off the surface of the photoreceptor with the cleaning blade for refreshing, the weight-average molecular weight of the polyarylate resin (S) is, for example, preferably 150,000 or less, more preferably 140,000 or less, and still more preferably 130,000 or less.

The molecular weight of the polyarylate resin (S) is a molecular weight in terms of polystyrene measured by gel permeation chromatography (GPC). The GPC is carried out using tetrahydrofuran as an eluent. The polyarylate resin (S) to be subjected to GPC is obtained by the following method.

The photoreceptor is dipped in various solvents (that may be a mixed solvent), and a solvent in which the surface layer (the charge transport layer or the single layer-type photosensitive layer) is dissolved is taken. The photoreceptor is dipped in a solvent in which the surface layer is dissolved, and the surface layer is extracted. The solution from which the surface layer has been extracted is dropped into a poor solvent for the polyarylate resin (S) (for example, a non-polar solvent such as hexane and toluene, or a lower alcohol such as methanol and isopropanol; the poor solvent may be a mixed solvent) to re-precipitate the polyarylate resin (S). The re-precipitation treatment is repeated twice as necessary. The precipitate is vacuum-dried to obtain the polyarylate resin (S).

The polyarylate resin (S) can be obtained by polycondensing a monomer providing the dicarboxylic acid unit (A), a monomer providing the diol unit (B), and other monomers as necessary using a method in the related art. Examples of the method of polycondensing the monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. Examples of documents related to the interfacial polymerization method include W. M. EARECKSON, J. Poly. Sci., XL399, 1959, and JP1965-1959B. Since the interfacial polymerization method enables the reaction to proceed faster than the reaction carried out by the solution polymerization method and also enables suppression of hydrolysis of the divalent carboxylic acid halide, as a result, a high-molecular-weight polyester resin can be obtained.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 1×10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and m or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while agitating the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing agitating or using ultrasonic waves, a sand mill, an attritor, or a ball mill, agitating or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while agitating and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to 1/2 from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A film thickness of the undercoat layer is set to, for example, preferably 15 μm or more and more preferably in a range of 20 μm or more and 50 μm or less.

### Interlayer

An interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. The deposition layer of the charge generation material is, for example, appropriate in a case where an incoherent light source such as a light emitting diode (LED) or an organic electroluminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 1×10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as an agitator, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

The charge transport layer is a layer containing a charge transport material and a binder resin.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

A polymer charge transport material may be used as the charge transport material. Examples of the polymer charge transport material include known compounds having charge transport properties, such as poly-N-vinylcarbazole and polysilane; and among these, a polyester-based polymer charge transport material is preferable.

Examples of the charge transport material or the polymer charge transport material include a polycyclic aromatic compound, an aromatic nitro compound, an aromatic amine compound, a heterocyclic compound, a hydrazone compound, a styryl compound, an enamine compound, a benzidine compound, a triarylamine compound (particularly, a triphenylamine compound), a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, a cyano compound, a benzofuran compound, an aniline compound, a butadiene compound, and a resin having a group derived from any of these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, paragraph 0116 of JP2013-097300A, paragraphs 0309 to 0316 of WO2019/070003A, paragraphs 0103 to 0107 of JP2018-159087A, and paragraphs 0102 to 0113 of JP2021-148818A.

From the viewpoint of charge mobility, for example, it is preferable that the charge transport material contains at least one selected from the group consisting of a compound (C1) represented by Formula (C1), a compound (C2) represented by Formula (C2), a compound (C3) represented by Formula (C3), and a compound (C4) represented by Formula (C4).

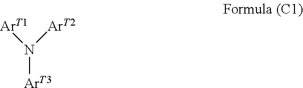

In Formula (C1), Ar^{T1}, Ar^{T2}, and Ar^{T3} are each independently an aryl group, —C₆H₄—C(R^{T4})═C(R^{T5})(R^{T6}) or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. In a case where R^{T5} and R^{T6}are aryl groups, the aryl groups may be linked through a divalent group of —C(R⁵¹)(R⁵²)— and/or —C(R⁶¹)═C(R⁶²)—. R⁵¹, R⁵², R⁶¹, and R⁶² are each independently a hydrogen atom or an alkyl group having 1 or more and 3 or less carbon atoms.

The group in Formula (C1) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of charge mobility, as the compound (C1), for example, a compound having at least one of an aryl group or —C₆H₄—CH═CH—CH═C(R^{T7})(R^{T8}) is preferable, and a compound (C′1) represented by Formula (C′1) is more preferable.

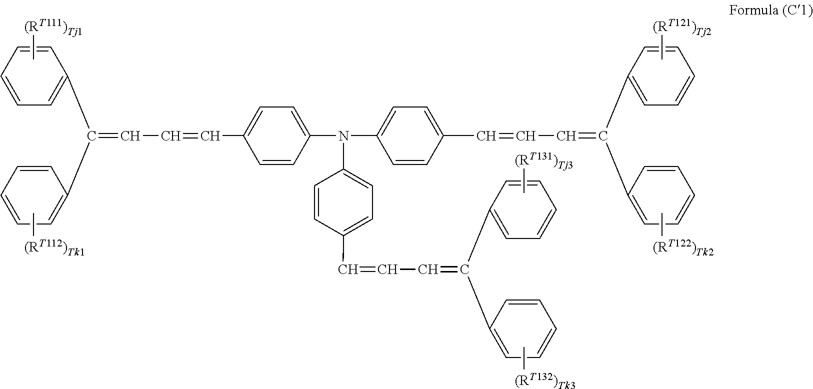

In Formula (C′1), R^{T111}, R^{T112}, R^{T121}, R^{T122}, R^{T131}, and R^{T132} are each independently a hydrogen atom, a halogen atom, an alkyl group (for example, preferably an alkyl group having 1 or more and 3 or less carbon atoms), an alkoxy group (for example, preferably an alkoxy group having 1 or more and 3 or less carbon atoms), a phenyl group, or a phenoxy group. Tj1, Tj2, Tj3, Tk1, Tk2, and Tk3 are each independently 0, 1, or 2.

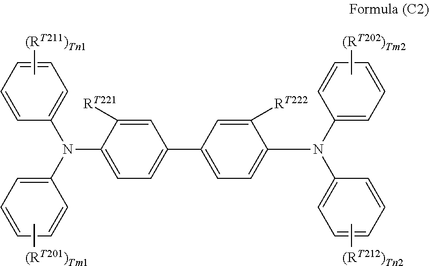

In Formula (C2), R^{T201}, R^{T202}, R^{T211}, and R^{T212} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}R^{T24}, and R^{T25} are each independently a hydrogen atom, an alkyl group, or an aryl group. R^{T221} and R^{T222} are each independently a hydrogen atom, a halogen atom, an alkyl group having 1 or more and 5 or less carbon atoms, or an alkoxy group having 1 or more and 5 or less carbon atoms. Tm1, Tm2, Tn1, and Tn2 are each independently 0, 1, or 2.

The group in Formula (C2) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the compound (C2), for example, a compound having at least one of an alkyl group, an aryl group, or —CH═CH—CH═C(R^{T24})(R^{T25}) is preferable, and a compound having two of an alkyl group, an aryl group, or —CH═CH—CH═C(R^{T24})(R^{T25}) is more preferable.

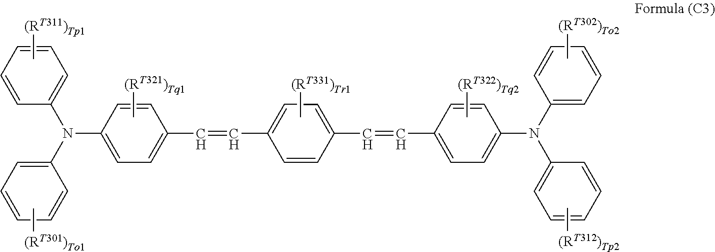

In Formula (C3), R^{T301}, R^{T302}, R^{T311}, and R^{T312} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}) or —CH═CH—CH═C(R^{T34})(R^{T35}). R^{T31}, R^{T32}, R^{T33}R^{T34}, and R^{T35} are each independently a hydrogen atom, an alkyl group, or an aryl group. R^{T321}R^{T322}, and R^{T331} are each independently a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr1 are each independently 0, 1, or 2.

The group in Formula (C3) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

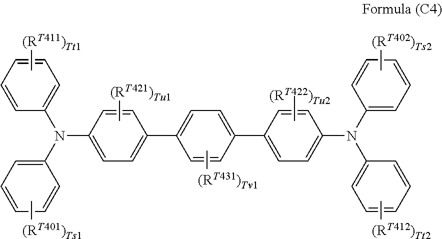

In Formula (C4), R^{T401}, R^{T402}, R^{T411}, and R^{T412} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}) or —CH═CH—CH═C(R^{T44})(R^{T45}). R^{T41}, R^{T42}, R^{T43}R^{T44}, and R^{T45} are each independently a hydrogen atom, an alkyl group, or an aryl group. R^{T421} R^{T422}, and R^{T431} are each independently a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 are each independently 0, 1, or 2.

The group in Formula (C4) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

A content of the charge transport material contained in the charge transport layer is, for example, preferably 20% by mass or more and 70% by mass or less, more preferably 25% by mass or more and 65% by mass or less, and still more preferably 30% by mass or more and 60% by mass or less with respect to the total mass of the charge transport layer.

The charge transport layer contains at least the polyarylate resin (S) as the binder resin. A proportion of the polyarylate resin (S) in the total amount of the binder resin contained in the charge transport layer is, for example, preferably 30% by mass or more, more preferably 40% by mass or more, still more preferably 50% by mass or more, and particularly preferably 55% by mass or more. In a case where the polyarylate resin (S) is used in combination with other resins, the other resins used in combination are, for example, preferably a polycarbonate resin.

The charge transport layer may contain a binder resin other than the polyarylate resin (S). Examples of other binder resins include a polycarbonate resin, a polyester resin other than the polyarylate resin (S), a polycarbonate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. The binder resins may be used alone or in combination of two or more kinds thereof.

The charge transport layer may also contain other known additives. Examples of the additive include an antioxidant, a leveling agent, an antifoaming agent, a filler, and a viscosity adjuster.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is, for example, 5 μm or more and 50 μm or less; and from the viewpoint of photosensitivity and abrasion life of the photoreceptor, for example, it is preferably 20 μm or more, more preferably 22 μm or more, and still more preferably 25 μm or more, and from the viewpoint of residual potential, for example, it is preferably 50 μm or less, more preferably 47 μm or less, and still more preferably 45 μm or less.

### Single Layer-Type Photosensitive Layer

A single layer-type photosensitive layer (charge generation/charge transport layer) is, for example, a layer containing a charge generation material, a charge transport material, a binder resin, and as necessary, other known additives. The materials are the same as the materials described in the sections of the charge generation layer and the charge transport layer.

The single layer-type photosensitive layer contains at least the polyarylate resin (S) as the binder resin. A proportion of the polyarylate resin (S) in the total amount of the binder resin contained in the single layer-type photosensitive layer is, for example, preferably 30% by mass or more, more preferably 40% by mass or more, still more preferably 50% by mass or more, and particularly preferably 55% by mass or more. In a case where the polyarylate resin (S) is used in combination with other resins, the other resins used in combination are, for example, preferably a polycarbonate resin.

A content of the charge generation material in the single layer-type photosensitive layer may be, for example, 0.1% by mass or more and 10% by mass or less, preferably 0.8% by mass or more and 5% by mass or less with respect to the total mass of the single layer-type photosensitive layer.

A content of the charge transport material contained in the single layer-type photosensitive layer is, for example, preferably 25% by mass or more and 70% by mass or less, more preferably 30% by mass or more and 65% by mass or less, and still more preferably 40% by mass or more and 60% by mass or less with respect to the total mass of the single layer-type photosensitive layer.

A method of forming the single layer-type photosensitive layer is the same as the method of forming the charge generation layer or the charge transport layer.

A film thickness of the single layer-type photosensitive layer is, for example, 5 μm or more and 50 μm or less; and from the viewpoint of photosensitivity and abrasion life of the photoreceptor, for example, it is preferably 10 μm or more, more preferably 12 μm or more, and still more preferably 15 μm or more, and from the viewpoint of residual potential, for example, it is preferably 50 μm or less, more preferably 47 μm or less, still more preferably 45 μm or less, and even more preferably 40 μm or less.

### Cleaning Blade

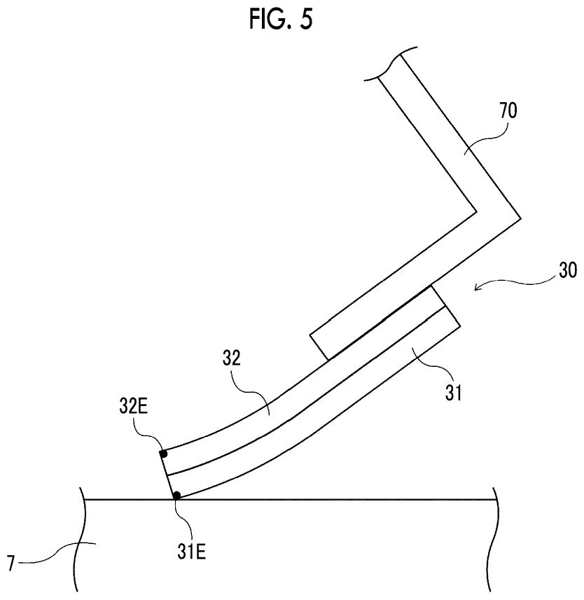

An exemplary embodiment of the cleaning blade will be described with reference to FIG. 5.

FIG. 5 is a schematic configuration view showing an example of a cleaning blade included in a photoreceptor cleaning device of the image forming apparatus according to the present exemplary embodiment. FIG. 5 is a cross section taken in a direction orthogonal to an axial direction of the photoreceptor, that shows a state in which the cleaning blade is in contact with the photoreceptor.

A cleaning blade 30 shown in FIG. 5 is used, for example, as the cleaning blade 131 in the cleaning device 13 shown in FIG. 1.

The cleaning blade 30 has a first polyurethane layer 31 and a second polyurethane layer 32. The cleaning blade 30 is joined to a support member 70 at the second polyurethane layer 32.

The first polyurethane layer 31 constitutes a surface of the cleaning blade 30, facing the photoreceptor 7.

A corner portion 31E of the first polyurethane layer 31 and the vicinity thereof are portions that come into contact with the rotating photoreceptor 7 to clean the surface of the photoreceptor 7.

The second polyurethane layer 32 is present on a back surface side (a surface opposite to the surface facing the photoreceptor 7) of the first polyurethane layer 31.

A corner portion 32E of the second polyurethane layer 32 is a corner portion facing the corner portion 31E of the first polyurethane layer 31 on a distal end surface of the cleaning blade 30.

The support member 70 has, for example, an L-shaped shape. The support member 70 is made of, for example, a metal such as aluminum and stainless steel. The support member 70 is joined, to the cleaning blade 30 with an adhesive, for example.

A pressing member (not shown) is joined to the support member 70. The pressing member presses the support member 70, and thus the cleaning blade 30 is pressed against the photoreceptor 7.

The hardness of the first polyurethane layer 31 is measured in the vicinity of the corner portion 31E. The hardness of the second polyurethane layer 32 is measured in the vicinity of the corner portion 32E.

The hardness is measured using a type A durometer defined in JIS K 7215:1986 “Durometer hardness test method for plastics” according to JIS K 6253:1997 “Hardness test method for vulcanized rubber and thermoplastic rubber”. Specifically, a stylus (indenter) of the type A durometer is pressed in the thickness direction at a position of 5 mm from the vertex of the corner portion toward the support member, and the maximum value of the guideline is read within 1 second. The measurement is performed approximately 10 times in a direction parallel to the axial direction of the photoreceptor, and an average value thereof is defined as the hardness of the polyurethane layer.

The hardness of the first polyurethane layer of the cleaning blade is 85 degrees or more and 95 degrees or less, and is, for example, preferably 86 degrees or more and 94 degrees or less, more preferably 87 degrees or more and 93 degrees or less, and still more preferably 88 degrees or more and 92 degrees or less.

The hardness of the second polyurethane layer of the cleaning blade is 55 degrees or more and 70 degrees or less, and is, for example, preferably 58 degrees or more and 69 degrees or less, more preferably 60 degrees or more and 68 degrees or less, and still more preferably 62 degrees or more and 67 degrees or less.

In a dynamic viscoelasticity measurement of the cleaning blade 30, in a case where a maximum value of a loss tangent in a range of 0° C. or higher and 30° C. or lower is defined as tanδ(Max) and a minimum value of the loss tangent is defined as tanδ(Min), for example, it is preferable that tanδ(Max)≤0.5 and tanδ(Max)−tanδ(Min)≤0.1 are satisfied.

By satisfying the above-described relationship of the loss tangent, stable cleaning performance can be exhibited without being affected by the high or low temperature.

tanδ(Max) is, for example, preferably 0.5 or less, more preferably 0.4 or less, and still more preferably 0.3 or less.

tanδ(Max)−tanδ(Min) is, for example, preferably 0.1 or less, more preferably 0.05 or less, and still more preferably 0.03 or less.

The dynamic viscoelasticity measurement of the cleaning blade 30 is as follows.

The cleaning blade 30 is cut into a rectangle having a length of 20 mm in a direction parallel to the axial direction of the photoreceptor and a length of 5 mm in a direction perpendicular to the axial direction of the photoreceptor, and the product is used as a sample.

The sample is placed on a measuring device, and the dynamic viscoelasticity is measured under the following measurement conditions to measure a storage elastic modulus and a loss elastic modulus. The loss tangent tan 6 is obtained from the storage elastic modulus and the loss elastic modulus, and a graph showing a relationship between the measurement temperature and the loss tangent tan 6 is drawn.
Measuring device: Exstar-DMS-6100 (Hitachi High-Tech Science Corporation (formerly Seiko Instruments Inc.))
Distance: 20 mm—Frequency: 1 Hz
Temperature rising range: start temperature; −40° C., end temperature; 60° C.
Temperature rising rate: 2° C./min

The hardness of the first polyurethane layer 31, the hardness of the second polyurethane layer 32, and the loss tangent tanδ of the cleaning blade 30 can be controlled, for example, by using a urethane rubber having a hard segment and a soft segment as a material, and controlling a content ratio of the hard segment and the soft segment included in the urethane rubber.

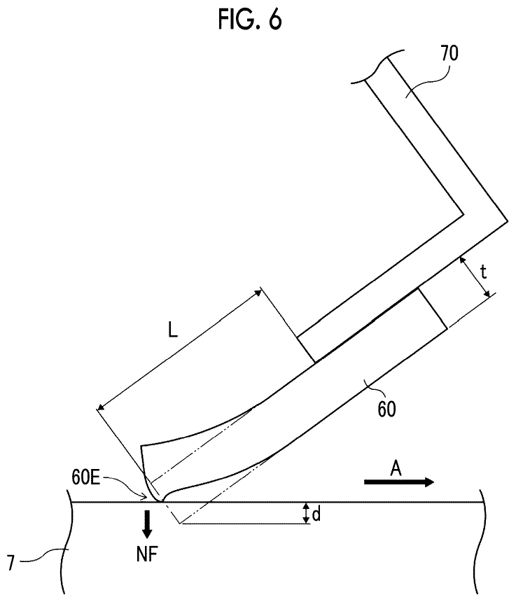

FIG. 6 is a schematic configuration view for describing the pressing pressure of the cleaning blade against the photoreceptor, and is a view showing the first polyurethane layer and the second polyurethane layer integrally without distinction. FIG. 6 shows a cross section taken in a direction orthogonal to the axial direction of the photoreceptor.

A cleaning blade 60 shown in FIG. 6 is joined to the support member 70 and is supported by the support member 70. A pressing member (not shown) is joined to the support member 70. The pressing member presses the support member 70, and thus the cleaning blade 60 is pressed against the photoreceptor 7. A corner portion 60E of the cleaning blade 60 and the vicinity thereof come into contact with the rotating photoreceptor 7 to clean the surface of the photoreceptor 7. The photoreceptor 7 rotates in a direction of an arrow A.

A pressing pressure NF (gf/mm) of the cleaning blade 60 against the photoreceptor 7 is a force calculated by the following expression.

$$NF = d \cdot E \cdot {t}^{3} / 4 {L}^{3}$$

E: Young's modulus of blade (gf/mm²)
L: free length of blade (mm); L in FIG. 6 (length of portion not joined to support member 70)
t: thickness of blade (mm); t in FIG. 6
d: amount of blade indentation into photoreceptor (mm); d in FIG. 6

The Young's modulus (gf/mm²) of the blade is measured according to JIS K 6251:1997 “Vulcanized rubber and thermoplastic rubber—Determination of tensile properties”. The sample is fixed to the measuring device, and the Young's modulus at 25% elongation is measured under the following measurement conditions.
Measuring device: Strograph VE1D (Toyo Seiki-Seisaku-syo, Ltd.)
Test piece size: dumbbell-shaped No. 3 shape
Test speed: 500 mm/min
Number of measurements: 3 times

A force ΔS (MPa) applied to a unit cross-sectional area and an elongation Δa at a unit length are measured, and a Young's modulus E (gf/mm²) is calculated according to the following expression.

$$E = 1 {0}^{2} \times Δ S / Δ a$$

Here, ΔS is calculated from the following expression using a load F (N), a sample thickness t (mm), and a sample width w (mm). Δa is calculated from the following expression using a sample reference length L (mm) and a sample elongation ΔL (mm) during the application of the load.

$$Δ S = F / ( w \times t )$$

$$Δ a = Δ L / L$$

From the viewpoint of suppressing the occurrence of the filming on the surface of the photoreceptor, a pressing pressure of the cleaning blade 60 against the photoreceptor 7 is, for example, preferably 1 gf/mm or more, more preferably 1.5 gf/mm or more, and still more preferably 2 gf/mm or more.

From the viewpoint of stabilizing the behavior of the tip of the cleaning blade and ensuring the cleaning performance, the pressing pressure of the cleaning blade 60 against the photoreceptor 7 is, for example, preferably 4 gf/mm or less, more preferably 3.5 gf/mm or less, and still more preferably 3 gf/mm or less.

Examples of a manufacturing method of the cleaning blade include the following.
The first polyurethane layer and the second polyurethane layer are separately manufactured, and the two layers are bonded to each other with an adhesive.
The material of the first polyurethane layer and the material of the second polyurethane layer are poured into a mold with a time difference, and an interface between the two materials is bonded.

The polyurethane is generally a polymer of polyisocyanate and polyol.

The polyurethane is, for example, preferably urethane rubber. The hardness of the urethane rubber can be controlled by a content ratio of a hard segment and a soft segment in the urethane rubber.

Examples of the polyisocyanate include 4,4′-diphenylmethane diisocyanate (MDI), 2,6-toluene diisocyanate (TDI), 1,6-hexane diisocyanate (HDI), 1,5-naphthalene diisocyanate (NDI), and 3,3-dimethylbiphenyl-4,4′-diisocyanate (TODI).

As the polyisocyanate, for example, MDI, NDI, or HDI is preferable.

The polyol includes a high-molecular-weight polyol and a low-molecular-weight polyol.

The high-molecular-weight polyol is a polyol having a number-average molecular weight of 500 or more (for example, preferably 500 or more and 5,000 or less). Examples of the high-molecular-weight polyol include known polyols such as a polyester polyol obtained by dehydration condensation of a low-molecular-weight polyol and a dibasic acid, a polycarbonate polyol obtained by a reaction between a low-molecular-weight polyol and an alkyl carbonate, a polycaprolactone polyol, and a polyether polyol.

Examples of the low-molecular-weight polyol include 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol.

Examples of the soft segment material include the high-molecular-weight polyol component among the polyols. One kind of the soft segment material may be used alone, or two or more kinds thereof may be used in combination.

As the hard segment material, a chain extender is used. Examples of the chain extender include polyols having a molecular weight of 300 or less, such as 1,4-butanediol, ethylene glycol, diethylene glycol, propylene glycol, dipropylene glycol, hexanediol, 1,4-cyclohexanediol, 1,4-cyclohexanedimethanol, xylene glycol, triethylene glycol, trimethylolpropane, glycerin, pentaerythritol, sorbitol, and 1,2,6-hexanetriol.

One kind of the hard segment material may be used alone, or two or more kinds thereof may be used in combination.

As the hard segment material, a resin having a functional group capable of reacting with an isocyanate group may be used. The resin is, for example, preferably a flexible resin, and is, for example, preferably a linear aliphatic resin from the viewpoint of flexibility. Examples thereof include an acrylic resin having two or more hydroxyl groups, a polybutadiene resin having two or more hydroxyl groups, and an epoxy resin having two or more epoxy groups.

The urethane rubber can be produced by forming a composition obtained by mixing a polyisocyanate, a polyol (for example, the hard segment material and the soft segment material), a crosslinking agent, and a catalyst. Examples of the crosslinking agent include a diol, a triol, and a tetraol. Examples of the catalyst include a tertiary amine, a quaternary ammonium salt, and an organic tin compound.

### Toner

The toner contains toner particles, and titanate compound particles and silica particles that are externally added to the toner particles. The toner is obtained by externally adding the external additive to the toner particles.

### Toner Particles

The toner particles are configured to contain, for example, a binder resin, a colorant, a release agent, and other additives.

### Binder Resin

Examples of the binder resin include vinyl-based resins including a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable.

Examples of the polyester resin include known polyester resins.

Examples of the polyester resin include a polycondensate of a polyvalent carboxylic acid and a polyhydric alcohol. As the polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the polyvalent carboxylic acids, for example, aromatic dicarboxylic acid is preferable.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of the polyvalent carboxylic acid may be used alone, or two or more kinds thereof may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of the polyhydric alcohol may be used alone, or two or more kinds thereof may be used in combination.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the polyester resin is, for example, preferably 5,000 or more and 1,000,000 or less, and more preferably 7,000 or more and 500,000 or less.

The number-average molecular weight (Mn) of the polyester resin is, for example, preferably 2,000 or more and 100,000 or less.

The molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC-HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

A content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

### Colorant

Examples of the colorant include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye; and inorganic pigments such as a titanium compound and silica.

The colorant is not limited to a substance having absorption in the visible light region. The colorant may be, for example, a substance having absorption in the near-infrared region, or may be a fluorescent colorant.

Examples of the colorant having absorption in the near-infrared region include an aminium salt-based compound, a naphthalocyanine-based compound, a squarylium-based compound, and a croconium-based compound.

Examples of the fluorescent colorant include the fluorescent colorants described in paragraph 0027 of JP2021-127431A.

The colorant may be a photoluminescent colorant. Examples of the photoluminescent colorant include metal powder such as aluminum, brass, bronze, nickel, stainless steel, and zinc; mica coated with titanium oxide or yellow iron oxide; a coated flaky inorganic crystal substrate such as barium sulfate, layered silicate, and silicate of layered aluminum; and monocrystal plate-shaped titanium oxide, basic carbonate, bismuth oxychloride, natural guanine, flaky glass powder, metal-deposited flaky glass powder.

One kind of the colorant may be used alone, or two or more kinds thereof may be used in combination.

As the colorant, a colorant having undergone a surface treatment as necessary may be used, or a dispersant may be used in combination with the colorant.

The toner particles may contain or may not contain a colorant. The toner may be a toner that does not contain a colorant in the toner particles, so-called transparent toner.

In a case where the toner particles contain the colorant, a content of the colorant is, for example, preferably 1% by mass or more and 30% by mass or less and more preferably 3% by mass or more and 15% by mass or less with respect to the total amount of the toner particles.

### Release Agent

Examples of the release agent include hydrocarbon-based wax; natural wax such as carnauba wax, rice wax, and candelilla wax; synthetic or mineral-petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower. The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, a charge control agent, and an inorganic powder. The additives are incorporated into the toner particles as internal additives.

### Characteristics of Toner Particles and the Like

The toner particles may be toner particles that have a single-layer structure or toner particles having a so-called core/shell structure that is configured with a core portion (core particle) and a coating layer (shell layer) coating the core portion. For example, the toner particles having a core/shell structure may be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The average particle size of the toner particles is measured using COULTER MULTISIZER II (manufactured by Beckman Coulter, Inc.) and using ISOTON-II (manufactured by Beckman Coulter, Inc.) as an electrolytic solution. A measurement sample in an amount of 0.5 mg or more and 50 mg or less is added to 2 ml of a 5% by mass aqueous solution of a surfactant (for example, preferably sodium alkylbenzene sulfonate), and the mixture is added to 100 ml or more and 150 ml or less of the electrolytic solution. The electrolytic solution in which the sample is added is subjected to a dispersion treatment for 1 minute with an ultrasonic disperser, and the particle size of the particles is measured in a range of 2 μm or more and 60 μm or less using COULTER MULTISIZER II with an aperture having an aperture size of 100 m. The number of particles to be sampled is 50,000. A volume distribution or a number distribution is drawn from a small size side based on the measured particle size distribution, and a particle size having a cumulative percentage of 50% is defined as the volume-average particle size D50v or the number-average particle size D50p.

The toner particles may be manufactured by any of a dry manufacturing method (for example, a kneading and pulverizing method) or a wet manufacturing method (for example, a coagulation method, a suspension polymerization method, or a dissolution suspension method). These manufacturing methods are not limited, and known manufacturing methods are adopted.

### Titanate Compound Particles

The titanate compound particles may be particles containing a titanate compound as a main component. The titanate compound is called metatitanate and is, for example, a salt generated from titanium oxide and another metal oxide or another metal carbonate.

As the titanate compound particles, for example, alkali earth metal titanate particles are preferable. The alkali earth metal titanate is a salt represented by a compositional formula RTiO₃ (in the formula, R is one or two or more kinds of alkali earth metals).

Examples of the titanate compound particles include particles of strontium titanate (SrTiO₃), calcium titanate (CaTiO₃), magnesium titanate (MgTiO₃), barium titanate (BaTiO₃), lead titanate (PbTiO₃), and zinc titanate (ZnTiO₃). One kind of the titanate compound particles may be used alone, or two or more kinds thereof may be used in combination.

The titanate compound particles may contain a dopant. Examples of the dopant include a lanthanoid (for example, lanthanum and cerium), silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, niobium, silver, and tin.

The strontium titanate particles may contain a dopant. Examples of the dopant include a lanthanoid (for example, lanthanum and cerium), silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, niobium, silver, and tin.

In a case where the titanate compound particles contain a dopant, an amount of the dopant is, for example, preferably 0.1 mol % or more and 20 mol % or less, more preferably 0.1 mol % or more and 15 mol % or less, and still more preferably 0.1 mol % or more and 10 mol % or less with respect to metal atoms other than titanium.

In a case where the alkali earth metal titanate particles contain a dopant, an amount of the dopant is, for example, preferably 0.1 mol % or more and 20 mol % or less, more preferably 0.1 mol % or more and 15 mol % or less, and still more preferably 0.1 mol % or more and 10 mol % or less with respect to metal atoms other than alkali earth metal atom.

In a case where the strontium titanate particles contain a dopant, an amount of the dopant is, for example, preferably 0.1 mol % or more and 20 mol % or less, more preferably 0.1 mol % or more and 15 mol % or less, and still more preferably 0.1 mol % or more and 10 mol % or less with respect to metal atoms other than strontium.

A surface of the titanate compound particles may be subjected to a hydrophobic treatment. Examples of a hydrophobic agent include a silane-based coupling agent and a silicone oil.

Examples of the silane-based coupling agent include hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, 7-methacryloxypropyltrimethoxysilane, and vinyltriacetoxysilane.

Examples of the silicone oil include dimethylpolysiloxane, methylhydrozinepolysiloxane, and methylphenylpolysiloxane.

From the viewpoint of suppressing the occurrence of fogging in the image, an average primary particle size of the titanate compound particles is, for example, preferably 20 nm or more, more preferably 25 nm or more, and still more preferably 30 nm or more.

From the viewpoint of suppressing the occurrence of blurring in the image, the average primary particle size of the titanate compound particles is, for example, preferably 100 nm or less, more preferably 80 nm or less, and still more preferably 60 nm or less.

A method of obtaining the average primary particle size of the titanate compound particles is as follows.

Using a scanning electron microscope (SEM) (manufactured by Hitachi High-Tech Corporation., S-4800) equipped with an energy dispersive X-ray analyzer (EDX device) (manufactured by HORIBA, Ltd., EMAX Evolution X-Max 80 mm²), an image of the toner is captured at a magnification of 40,000. 200 titanate compound particles are specified from one visual field based on the presence of a titanium element and an oxygen element by EDX analysis. The image of 200 titanate compound particles is analyzed by the image processing/analysis software WinRoof (MITANI CORPORATION). An equivalent circle diameter of the primary particles is determined, and in distribution of the equivalent circle diameter, the equivalent circular diameter below which the cumulative percentage of particles having smaller equivalent circular diameter reaches 50% is defined as an average primary particle size.

The amount of the titanate compound particles externally added with respect to 100 parts by mass of the toner particles is, for example, preferably 0.1 parts by mass or more and 3.0 parts by mass or less, more preferably 0.3 parts by mass or more and 2.0 parts by mass or less, and still more preferably 0.5 parts by mass or more and 1.5 parts by mass or less.

The amount of the alkali earth metal titanate particles externally added with respect to 100 parts by mass of the toner particles is, for example, preferably 0.1 parts by mass or more and 3.0 parts by mass or less, more preferably 0.3 parts by mass or more and 2.0 parts by mass or less, and still more preferably 0.5 parts by mass or more and 1.5 parts by mass or less.

The amount of the strontium titanate particles externally added with respect to 100 parts by mass of the toner particles is, for example, preferably 0.1 parts by mass or more and 3.0 parts by mass or less, more preferably 0.3 parts by mass or more and 2.0 parts by mass or less, and still more preferably 0.5 parts by mass or more and 1.5 parts by mass or less.

The amount of the lanthanum-doped strontium titanate particles externally added with respect to 100 parts by mass of the toner particles is, for example, preferably 0.1 parts by mass or more and 3.0 parts by mass or less, more preferably 0.3 parts by mass or more and 2.0 parts by mass or less, and still more preferably 0.5 parts by mass or more and 1.5 parts by mass or less.

### Silica Particles

The silica particles may be dry silica or wet silica. Examples of the dry silica include silica by a combustion method (fumed silica) obtained by combustion of a silane compound and silica by a deflagration method obtained by explosive combustion of metallic silicon powder. Examples of the wet silica include wet silica obtained by a neutralization reaction between sodium silicate and a mineral acid (silica by a precipitation method synthesized and aggregated under alkaline conditions, silica by a gelation method synthesized and aggregated under acidic conditions), colloidal silica obtained by alkalifying and polymerizing acidic silicate, and sol-gel silica obtained by the hydrolysis of an organic silane compound (for example, alkoxysilane).

From the viewpoint of improving the action of the silica particles as the external additive, the silica particles are, for example, preferably silica particles having a surface subjected to a hydrophobic treatment, and more preferably silica particles having a surface subjected to a hydrophobic treatment with a silicon-containing organic compound. Examples of the silicon-containing organic compound include the same silicon-containing organic compound for the titanate compound particles as described above.

From the viewpoint of suppressing the occurrence of fogging in the image, an average primary particle size of the silica particles is, for example, preferably 50 nm or more, more preferably 60 nm or more, and still more preferably 70 nm or more.

From the viewpoint of suppressing the occurrence of blurring and fogging in the image, the average primary particle size of the silica particles is, for example, preferably 150 nm or less, more preferably 120 nm or less, and still more preferably 100 nm or less.

As the silica particles, silica particles having a relatively large particle diameter and silica particles having a relatively small particle diameter may be used in combination.

A method of measuring the average primary particle size of the silica particles is as follows.

Using a scanning electron microscope (SEM) (manufactured by Hitachi High-Tech Corporation., S-4800) equipped with an energy dispersive X-ray analyzer (EDX device) (manufactured by HORIBA, Ltd., EMAX Evolution X-Max 80 mm²), an image of the toner is captured at a magnification of 40,000. 200 silica particles are specified from one visual field based on the presence of an Si element by EDX analysis. The image of 200 silica particles is analyzed by the image processing/analysis software WinRoof (MITANI CORPORATION). An equivalent circle diameter of each of the primary particle images is obtained. In the distribution of equivalent circle diameter, the equivalent circular diameter below which the cumulative percentage of particles having smaller equivalent circular diameter reaches 50% is defined as an average primary particle size.

The amount of the silica particles externally added with respect to 100 parts by mass of the toner particles is, for example, preferably 0.1 parts by mass or more and 3.0 parts by mass or less, more preferably 0.3 parts by mass or more and 2.0 parts by mass or less, and still more preferably 0.5 parts by mass or more and 1.5 parts by mass or less.

The total amount of the silica particles and the titanate compound particles externally added with respect to 100 parts by mass of the toner particles is, for example, preferably 0.3 parts by mass or more and 5.0 parts by mass or less, more preferably 0.5 parts by mass or more and 4.0 parts by mass or less, and still more preferably 1.0 part by mass or more and 3.0 parts by mass or less.

The total amount of the silica particles and the alkali earth metal titanate particles externally added with respect to 100 parts by mass of the toner particles is, for example, preferably 0.3 parts by mass or more and 5.0 parts by mass or less, more preferably 0.5 parts by mass or more and 4.0 parts by mass or less, and still more preferably 1.0 part by mass or more and 3.0 parts by mass or less.

The total amount of the silica particles and the strontium titanate particles externally added with respect to 100 parts by mass of the toner particles is, for example, preferably 0.3 parts by mass or more and 5.0 parts by mass or less, more preferably 0.5 parts by mass or more and 4.0 parts by mass or less, and still more preferably 1.0 part by mass or more and 3.0 parts by mass or less.

The total amount of the lanthanum-doped strontium titanate particles externally added with respect to 100 parts by mass of the toner particles is, for example, preferably 0.3 parts by mass or more and 5.0 parts by mass or less, more preferably 0.5 parts by mass or more and 4.0 parts by mass or less, and still more preferably 1.0 part by mass or more and 3.0 parts by mass or less.

### Other External Additives

The toner may be a toner to which an external additive other than the titanate compound particles and the silica particles are externally added. Examples of the external additive other than the titanate compound particles and the silica particles include inorganic particles such as TiO₂, Al₂O₃, CuO, ZnO, SnO₂, CeO₂, Fe₂O₃, MgO, BaO, CaO, K₂O, Na₂O, ZrO₂, CaO—SiO₂, K₂O·(TiO₂)ₙ, Al₂O₃·2SiO₂, CaCO₃, MgCO₃, BaSO₄, and MgSO₄; and resin particles such as polystyrene, polymethyl methacrylate, and a melamine resin. One kind of these agents may be used alone, or two or more kinds thereof may be used in combination.

For example, it is preferable that the surface of the inorganic particles as an external additive is subjected to a hydrophobic treatment. Examples of the hydrophobic agent include a silane-based coupling agent, silicone oil, a titanate-based coupling agent, and an aluminum-based coupling agent.

### Developer

The developer may be a one-component developer containing only a toner or a two-component developer obtained by mixing a toner and a carrier.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin. The magnetic powder dispersion-type carrier or the resin impregnation-type carrier may be a carrier obtained by coating the surface of a core material with a resin.

Examples of the magnetic powder include magnetic metals such as iron, nickel, and cobalt; and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene/acrylic acid ester copolymer, a straight silicone resin configured with an organosiloxane bond, a product obtained by modifying the straight silicone resin, a fluororesin, polyester, polycarbonate, a phenol resin, and an epoxy resin. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

Examples of a method of coating the surface of the core material with a resin include a method of using a solution for forming a coating layer obtained by dissolving the coating resin and various additives (used as necessary) in an appropriate solvent. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### EXAMPLES

Hereinafter, the present exemplary embodiments will be specifically described based on Examples. However, the present exemplary embodiments are not limited to Examples. In the following description, unless otherwise specified, “parts” and “%” are based on mass.

In the following description, the synthesis, the treatment, the production, the test, and the like are carried out at room temperature (25° C.±3C) unless otherwise specified.

### Production of Strontium Titanate Particles

La-doped strontium titanate particles having a surface hydrophobized with isobutyl trimethoxysilane (i-BTMS) and strontium titanate particles without a dopant and without a surface treatment are produced by a known wet method and surface treatment method. A particle size of the strontium titanate particles is controlled by adjusting a length of time for which the material is dropped during granulation by the wet method. Table 1 shows physical properties of the strontium titanate particles.

TABLE 1
Strontium titanate particles

| | | | | Surface |
|---|---|---|---|---|
| | | Dope | Average primary | treatment |
| No. | Dopant | amount | particle size | agent |
| — | Type | Mole | nm | Type |
| (1) | La | 0.5 | 40 | i-BTMS |
| (2) | La | 0.5 | 15 | i-BTMS |
| (3) | La | 0.5 | 20 | i-BTMS |
| (4) | La | 0.5 | 100 | i-BTMS |
| (5) | La | 0.5 | 110 | i-BTMS |
| (6) | — | 0 | 40 | — |

### Production of Silica Particles

Silica particles having a surface hydrophobized with 1,1,1,3,3,3-hexamethyldisilazane (HMDS) are produced by a known sol-gel method and surface treatment method. A particle size of the silica particles is controlled by adjusting a length of time for which the material is dropped during granulation by the sol-gel method. Table 2 shows physical properties of the silica particles.

TABLE 2
Silica particles

| | Production | Average primary | Surface |
|---|---|---|---|
| No. | method | particle size | treatment agent |
| — | — | nm | Type |
| (1) | Sol-gel method | 80 | HMDS |
| (2) | Sol-gel method | 40 | HMDS |
| (3) | Sol-gel method | 50 | HMDS |
| (4) | Sol-gel method | 150 | HMDS |
| (5) | Sol-gel method | 160 | HMDS |

### Synthesis of Polyarylate Resin (S)

Polyarylate resins (1) to (8) that are the polyarylate resin (S) are synthesized. In the synthesis of all these resins, polymerization is carried out in the presence of a terminal blocking agent of 4-tert-butylphenol to block a terminal of the polyarylate resin.

Table 3 shows units and formulations constituting the polyarylate resins.

A1-3 and the like listed in Table 3 are specific examples of the dicarboxylic acid unit (A) described above.

B1-4 and the like listed in Table 3 are specific examples of the diol unit (B) described above.

TABLE 3

| Polyarylate | Dicarboxylic acid | | | | Weight-average |
|---|---|---|---|---|---|
| resin | unit (A) | | Diol unit (B) | | molecular weight |
| No. | No. | mol % | No. | mol % | k |
| (1) | A1-3 | 50 | B1-4 | 50 | 120 |
| (2) | A1-3 | 50 | B2-6 | 50 | 120 |
| (3) | A1-3 | 50 | B3-3 | 50 | 120 |
| (4) | A1-3 | 50 | B4-3 | 50 | 120 |
| (5) | A2-3 | 50 | B5-1 | 50 | 120 |
| (6) | A2-3 | 50 | B6-4 | 50 | 120 |
| (7) | A3-3 | 50 | B7-2 | 50 | 80 |
| (8) | A3-3 | 50 | B8-2 | 50 | 150 |

### Synthesis of Polycarbonate Resin

A polycarbonate resin (1) having a viscosity-average molecular weight of 80,000, that consists of the following constitutional units, is synthesized according to a method in the related art.

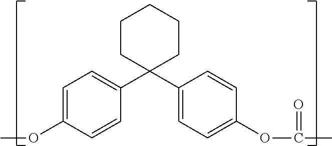

### Production of Photoreceptor

### Formation of Undercoat Layer

An aluminum cylindrical tube having an outer diameter of 30 mm, a length of 365 mm, and a thickness of 1.6 mm is prepared as a conductive substrate.

100 parts of zinc oxide (average particle size: 70 nm, specific surface area: 15 m²/g, Tayca Corporation) is stirred and mixed with 500 parts of toluene, 1.3 parts of a silane coupling agent (N-2-(aminoethyl)-3-aminopropyltrimethoxysilane, trade name: KBM603, Shin-Etsu Chemical Co., Ltd.) is added thereto, and the mixture is stirred for 2 hours. Thereafter, the toluene is distilled off under reduced pressure and baked at 120° C. for 3 hours to obtain zinc oxide subjected to a surface treatment with the silane coupling agent.

110 parts of the surface-treated zinc oxide is stirred and mixed with 500 parts of tetrahydrofuran, a solution obtained by dissolving 0.6 parts of alizarin in 50 parts of tetrahydrofuran is added thereto, and the mixture is stirred at 50° C. for 5 hours. Thereafter, the solid content is separated by filtration by carrying out filtration under reduced pressure, and dried at 60° C. under reduced pressure, thereby obtaining zinc oxide with alizarin.

100 parts of a solution obtained by dissolving 60 parts of the zinc oxide with alizarin, 13.5 parts of a curing agent (blocked isocyanate, trade name: SUMIDUR 3175, Sumitomo Bayer Urethane Co., Ltd.), and 15 parts of a butyral resin (trade name: S-LEC BM-1, Sekisui Chemical Co., Ltd.) in 68 parts of methyl ethyl ketone is mixed with 5 parts of methyl ethyl ketone, and the mixture is dispersed in a sand mill for 2 hours using glass beads with a diameter of 1 mmφ, thereby obtaining a dispersion liquid. 0.005 parts of dioctyl tin dilaurate as a catalyst and 4 parts of silicone resin particles (trade name: TOSPEARL 145, Momentive Performance Materials Inc.) are added to the dispersion liquid to obtain a coating solution for forming an undercoat layer. The outer peripheral surface of the conductive substrate is coated with the coating solution for forming an undercoat layer by a dip coating method, and dried and cured at 185° C. for 35 minutes to form an undercoat layer with an average thickness of 25 μm.

### Formation of Charge Generation Layer

A mixture of 15 parts of hydroxygallium phthalocyanine as a charge generation material (having diffraction peaks at positions where Bragg angles (2θ±0.2°) in the X-ray diffraction spectrum using CuKα characteristic X-rays are at least of 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads with a diameter of 1 mm. 175 parts of n-butyl acetate and 180 parts of methyl ethyl ketone are added to the dispersion liquid, and the mixture is stirred to obtain a coating solution for forming a charge generation layer. The undercoat layer is dipped in and coated with the coating solution for forming a charge generation layer, and dried at room temperature (25° C.±3C) to form a charge generation layer having an average thickness of 0.25 m.

### Formation of Charge Transport Layer

| | |
|---|---|
| Binder resin: polyarylate resin or polycarbonate resin | 60 parts |
| Charge transport material: CTM-1 | 40 parts |
| Tetrahydrofuran | 270 parts |
| Toluene: | 30 parts |

The above-described materials are stirred and mixed to obtain a coating solution for forming a charge transport layer. The charge generation layer is dipped and coated with the coating solution for forming a charge transport layer, and dried at 145° C. for 30 minutes to form a charge transport layer having an average thickness of 40 m.

The types of the binder resins used in the production of the photoreceptors (1) to (9) are as shown in Table 4.

A chemical structure of the charge transport material CTM-1 is shown below.

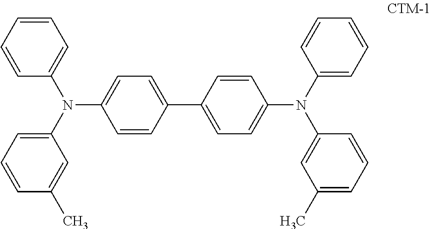 [SMILES: Cc1cccc(N(c2ccccc2)c2ccc(-c3ccc(N(c4ccccc4)c4cccc(C)c4)cc3)cc2)c1]

TABLE 4

| Photoreceptor | Binder resin |
|---|---|
| No. | Type |
| (1) | Polyarylate resin (1) |
| (2) | Polyarylate resin (2) |
| (3) | Polyarylate resin (3) |
| (4) | Polyarylate resin (4) |
| (5) | Polyarylate resin (5) |
| (6) | Polyarylate resin (6) |
| (7) | Polyarylate resin (7) |
| (8) | Polyarylate resin (8) |
| (9) | Polycarbonate resin (PC1) |

### Production of Cleaning Blade

A polyol for the second polyurethane layer is obtained by polymerizing a polyol material shown in Table 5 at 1:1 (molar ratio) and performing a treatment in which the terminal is an OH group. The material of the second polyurethane layer prepared using the polyol, a chain extender, a polyisocyanate, and a crosslinking agent at molar ratios shown in Table 5 is poured into a mold. Next, the material of the first polyurethane layer prepared in the same manner is poured into the mold to mold a urethane rubber sheet having a two-layer structure. The hardness of the first polyurethane layer and the hardness of the second polyurethane layer are controlled depending on the type and formulation of the materials. Table 5 shows the hardness, the material type, and the formulation of each layer, and the loss tangent tanδ of the cleaning blade.

TABLE 5

| | | | | | | | | | | Second |
|---|---|---|---|---|---|---|---|---|---|---|
| | First polyurethane layer | | | | | | | | | polyurethane |
| Cleaning | | Polyol | | Chain extender | | Polyisocyanate | | Crosslinking agent | | layer |
| blade | Hardness | | Blending | | Blending | | Blending | | Blending | Hardness |
| No. | Degree | Material | amount | Material | amount | Material | amount | Material | amount | Degree |
| (1) | 90 | Adipic acid | 58 | Butanediol | 8.1 | MDI | 33 | Trimethylolpropane | 0.9 | 65 |
| | | and | | | | | | | | |
| | | nonanediol | | | | | | | | |
| | | (molar ratio | | | | | | | | |
| | | 1:1) | | | | | | | | |
| (2) | 84 | Adipic acid | 67 | Butanediol | 10.1 | MDI | 22 | Trimethylolpropane | 0.9 | 65 |
| | | and | | | | | | | | |
| | | propanediol | | | | | | | | |
| | | (molar ratio | | | | | | | | |
| | | 1:1) | | | | | | | | |
| (3) | 85 | Adipic acid | 65 | Butanediol | 12.0 | MDI | 22.3 | Trimethylolpropane | 0.7 | 65 |
| | | and | | | | | | | | |
| | | nonanediol | | | | | | | | |
| | | (molar ratio | | | | | | | | |
| | | 1:1) | | | | | | | | |
| (4) | 95 | Adipic acid | 55 | Hexanediol | 8.8 | MDI | 35 | Trimethylolpropane | 1.2 | 65 |
| | | and | | | | | | | | |
| | | decanediol | | | | | | | | |
| | | (molar ratio | | | | | | | | |
| | | 1:1) | | | | | | | | |
| (5) | 96 | Adipic acid | 55 | Tetradecanediol | 8.7 | MDI | 35 | Trimethylolpropane | 1.3 | 65 |
| | | and | | | | | | | | |
| | | heptanediol | | | | | | | | |
| | | (molar ratio | | | | | | | | |
| | | 1:1) | | | | | | | | |
| (6) | 90 | Adipic acid | 58 | Butanediol | 8.1 | MDI | 33 | Trimethylolpropane | 0.9 | 53 |
| | | and | | | | | | | | |
| | | nonanediol | | | | | | | | |
| | | (molar ratio | | | | | | | | |
| | | 1:1) | | | | | | | | |
| (7) | 90 | Adipic acid | 58 | Butanediol | 8.1 | MDI | 33 | Trimethylolpropane | 0.9 | 55 |
| | | and | | | | | | | | |
| | | nonanediol | | | | | | | | |
| | | (molar ratio | | | | | | | | |
| | | 1:1) | | | | | | | | |
| (8) | 90 | Adipic acid | 58 | Butanediol | 8.1 | MDI | 33 | Trimethylolpropane | 0.9 | 70 |
| | | and | | | | | | | | |
| | | nonanediol | | | | | | | | |
| | | (molar ratio | | | | | | | | |
| | | 1:1) | | | | | | | | |
| (9) | 90 | Adipic acid | 58 | Butanediol | 8.1 | MDI | 33 | Trimethylolpropane | 0.9 | 72 |
| | | and | | | | | | | | |
| | | nonanediol | | | | | | | | |
| | | (molar ratio | | | | | | | | |
| | | 1:1) | | | | | | | | |
| (10) | 87 | Adipic acid | 62 | Butanediol | 10.0 | MDI | 27 | Trimethylolpropane | 1.0 | 58 |
| | | and | | | | | | | | |
| | | nonanediol | | | | | | | | |
| | | (molar ratio | | | | | | | | |
| | | 1:1) | | | | | | | | |

| | Second polyurethane layer | | | | | | | | Cleaning blade | |
|---|---|---|---|---|---|---|---|---|---|---|
| Cleaning | Polyol | | Chain extender | | Polyisocyanate | | Crosslinking agent | | | tanδ(Max) − |
| blade | | Blending | | Blending | | Blending | | Blending | tanδ(Max) | tanδ(Min) |
| No. | Material | amount | Material | amount | Material | amount | Material | amount | — | — |
| (1) | Adipic acid | 72 | Butanediol | 12.3 | MDI | 15 | Trimethylolpropane | 0.7 | 0.42 | 0.04 |
| | and | | | | | | | | | |
| | nonanediol | | | | | | | | | |
| | (molar ratio | | | | | | | | | |
| | 1:1) | | | | | | | | | |
| (2) | Adipic acid | 72 | Butanediol | 12.3 | MDI | 15 | Trimethylolpropane | 0.7 | 0.51 | 0.11 |
| | and | | | | | | | | | |
| | propanediol | | | | | | | | | |
| | (molar ratio | | | | | | | | | |
| | 1:1) | | | | | | | | | |
| (3) | Adipic acid | 72 | Butanediol | 12.3 | MDI | 15 | Trimethylolpropane | 0.7 | 0.49 | 0.10 |
| | and | | | | | | | | | |
| | nonanediol | | | | | | | | | |
| | (molar ratio | | | | | | | | | |
| | 1:1) | | | | | | | | | |
| (4) | Adipic acid | 72 | Butanediol | 12.3 | MDI | 15 | Trimethylolpropane | 0.7 | 0.38 | 0.09 |
| | and | | | | | | | | | |
| | decanediol | | | | | | | | | |
| | (molar ratio | | | | | | | | | |
| | 1:1) | | | | | | | | | |
| (5) | Adipic acid | 72 | Butanediol | 12.3 | MDI | 15 | Trimethylolpropane | 0.7 | 0.35 | 0.13 |
| | and | | | | | | | | | |
| | heptanediol | | | | | | | | | |
| | (molar ratio | | | | | | | | | |
| | 1:1) | | | | | | | | | |
| (6) | Adipic acid | 74 | Propanediol | 12.6 | MDI | 13 | Trimethylolpropane | 0.4 | 0.53 | 0.15 |
| | and | | | | | | | | | |
| | nonanediol | | | | | | | | | |
| | (molar ratio | | | | | | | | | |
| | 1:1) | | | | | | | | | |
| (7) | Adipic acid | 74 | Hexanediol | 11.4 | MDI | 14 | Trimethylolpropane | 0.6 | 0.48 | 0.07 |
| | and | | | | | | | | | |
| | nonanediol | | | | | | | | | |
| | (molar ratio | | | | | | | | | |
| | 1:1) | | | | | | | | | |
| (8) | Adipic acid | 68 | Hexanediol | 13 | MDI | 18 | Trimethylolpropane | 1.0 | 0.38 | 0.00 |
| | and | | | | | | | | | |
| | nonanediol | | | | | | | | | |
| | (molar ratio | | | | | | | | | |
| | 1:1) | | | | | | | | | |
| (9) | Adipic acid | 67 | Butanediol | 13 | MDI | 19 | Trimethylolpropane | 1.0 | 0.40 | 0.14 |
| | and | | | | | | | | | |
| | nonanediol | | | | | | | | | |
| | (molar ratio | | | | | | | | | |
| | 1:1) | | | | | | | | | |
| (10) | Adipic acid | 68 | Butanediol | 15.2 | MDI | 16 | Trimethylolpropane | 0.8 | 0.51 | 0.13 |
| | and | | | | | | | | | |
| | nonanediol | | | | | | | | | |
| | (molar ratio | | | | | | | | | |
| | 1:1) | | | | | | | | | |

### Example 1

### Production of Toner and Developer

Black toner particles (volume-average particle size: 5 in) having a core-shell structure are prepared. A binder resin of the core is an amorphous polyester resin and a crystalline polyester resin, and a binder resin of the shell is an amorphous polyester resin.

1 part of strontium titanate particles (1) and 2.5 parts of silica particles (1) are mixed with 100 parts of the above-described black toner particles, and the mixture is mixed at 10,000 rpm for 30 seconds with a sample mill. Thereafter, the mixture is sieved using a vibration sieve having an opening size of 45 m, thereby obtaining an externally added toner.

A carrier in which ferrite particles (average particle size: 35 m) are coated with a resin is prepared. The coating resin layer is a resin layer in which carbon black is dispersed in a cyclohexyl methacrylate-monoethylaminoethyl methacrylate copolymer.

The externally added toner and the carrier are charged into a V-blender and stirred for 20 minutes. Thereafter, the mixture is sieved using a sieve having an opening size of 212 m, thereby obtaining a developer.

### Production of Image Forming Apparatus

A photoreceptor (1) and a cleaning blade (1) are mounted on a modified machine of an image forming apparatus DocuCentre-V C7775 (FUJIFILM Business Innovation Corp.), and the above-described developer is contained in a developing device.

### Examples 2 to 24 and Comparative Examples 1 to 6

A photoreceptor and a cleaning blade are mounted on the image forming apparatus in combinations shown in Table 6. In addition, the toner and the developer are produced by changing the toner external additive as shown in Table 6, and the toner and the developer are contained in the developing device.

### Performance Evaluation

The following performance evaluations are performed using each image forming apparatus of Examples and Comparative Examples. The results are shown in Table 6.

### Blurring

In an environment of a temperature of 28° C. and a relative humidity of 85%, 6,000 black solid images with an image density of 100% are formed on A4 plain paper. The 6000th image is visually observed, and the presence or absence of white blurring is classified as follows.
A: no blurring is observed.
B: blurring is observed in a region of less than 3%, but there is no problem in practical use.
C: blurring is observed in a region of less than 5%, but it is within a practically acceptable range.
D: blurring is clearly observed, that is a problem in practical use.

### Fogging

In an environment of a temperature of 15° C. and a relative humidity of 10%, 10,000 black images with an image density of 5% are formed on A4 plain paper. Next, 10 black images with an image density of 40% are formed on A4 plain paper. The 10 images are observed with the naked eye and a 5× loupe, and the presence or absence of fogging is classified as follows.
G1: no fogging is observed on all of the 10 sheets. G2: 1 sheet has fogging with the loupe, but there is no problem in practical use.
G3: a plurality of sheets have fogging with the loupe, but it is within a practically acceptable range.
G4: a plurality of sheets have fogging with the naked eye, that is a problem in practical use.
G5: all of the 10 sheets have fogging with the naked eye, that is a problem in practical use.

### Density Unevenness

In an environment of a temperature of 28° C. and a relative humidity of 85%, 100,000 black images with an image density of 5% are formed on A4 plain paper. Next, one black halftone image with an image density of 50% is formed on A4 plain paper. The one image is visually observed, and the presence or absence of density unevenness is classified as follows.
A: no density unevenness is observed.
B: slight density unevenness is observed in less than 20% of the entire image region, but there is no problem in practical use.
C: density unevenness is confirmed in 20% or more and less than 60% of the entire image region, but it is within a practically acceptable range.
D: clear density unevenness is observed in 60% or more of the entire image region, that is a problem in practical use.

### Filming

In an environment of a temperature of 28° C. and a relative humidity of 85%, 10,000 black images with an image density of 1% are formed on A4 plain paper. Next, one black halftone image with an image density of 50% is formed on A4 plain paper. The one image is observed with the naked eye and the surface of the photoreceptor is observed with a microscope, and the presence or absence of filming is classified as follows.
G1: photoreceptor has no filming, and there are no white streaks in the image.
G2: photoreceptor has slight filming, and there are no white streaks in the image.
G3: photoreceptor has streak-like filming, but there are no white streaks in the image.
G4: photoreceptor has streak-like filming, and the image has white streaks.

TABLE 6

| | Toner external additive | | | | Binder resin of charge transport | | | | | | |
|---|---|---|---|---|---|---|---|---|---|---|---|
| | Strontium | | | | layer in photoreceptor | | | | | | |
| | titanate particles | | Silica particles | | | | Dicarboxylic | | | | |
| | | Average | | Average | | | acid | Diol | Weight- | | |
| | | primary | | primary | | Binder | unit | unit | average | Cleaning blade | |
| | | particle | | particle | | resin | (A) | (B) | molecular | | First PU |
| | No. | size | No. | size | No. | Type | No. | No. | weight | No. | layer |
| | — | nm | — | nm | — | — | — | — | k | — | Hardness |
| Comparative | — | | (1) | 80 | (1) | PAR(1) | A1-3 | B1-4 | 120 | (1) | 90 |
| Example 1 | | | | | | | | | | | |
| Comparative | (1) | 40 | (1) | 80 | (9) | PC(1) | — | — | — | (1) | 90 |
| Example 2 | | | | | | | | | | | |
| Example 1 | (1) | 40 | (1) | 80 | (1) | PAR(1) | A1-3 | B1-4 | 120 | (1) | 90 |
| Example 2 | (2) | 15 | (1) | 80 | (1) | PAR(1) | A1-3 | B1-4 | 120 | (1) | 90 |
| Example 3 | (3) | 20 | (1) | 80 | (1) | PAR(1) | A1-3 | B1-4 | 120 | (1) | 90 |
| Example 4 | (4) | 100 | (1) | 80 | (1) | PAR(1) | A1-3 | B1-4 | 120 | (1) | 90 |
| Example 5 | (5) | 110 | (1) | 80 | (1) | PAR(1) | A1-3 | B1-4 | 120 | (1) | 90 |
| Example 6 | (6) | 40 | (1) | 80 | (1) | PAR(1) | A1-3 | B1-4 | 120 | (1) | 90 |
| Example 7 | (1) | 40 | (2) | 40 | (1) | PAR(1) | A1-3 | B1-4 | 120 | (1) | 90 |
| Example 8 | (1) | 40 | (3) | 50 | (1) | PAR(1) | A1-3 | B1-4 | 120 | (1) | 90 |
| Example 9 | (1) | 40 | (4) | 150 | (1) | PAR(1) | A1-3 | B1-4 | 120 | (1) | 90 |
| Example 10 | (1) | 40 | (5) | 160 | (1) | PAR(1) | A1-3 | B1-4 | 120 | (1) | 90 |
| Example 11 | (1) | 40 | (1) | 80 | (2) | PAR(2) | A1-3 | B2-6 | 120 | (1) | 90 |
| Example 12 | (1) | 40 | (1) | 80 | (3) | PAR(3) | A1-3 | B3-3 | 120 | (1) | 90 |
| Example 13 | (1) | 40 | (1) | 80 | (4) | PAR(4) | A1-3 | B4-3 | 120 | (1) | 90 |
| Example 14 | (1) | 40 | (1) | 80 | (5) | PAR(5) | A2-3 | B5-1 | 120 | (1) | 90 |
| Example 15 | (1) | 40 | (1) | 80 | (6) | PAR(6) | A2-3 | B6-4 | 120 | (1) | 90 |
| Example 16 | (1) | 40 | (1) | 80 | (7) | PAR(7) | A3-3 | B7-2 | 80 | (1) | 90 |
| Example 17 | (1) | 40 | (1) | 80 | (8) | PAR(8) | A3-3 | B8-2 | 150 | (1) | 90 |
| Comparative | (1) | 40 | (1) | 80 | (1) | PAR(1) | A1-3 | B1-4 | 120 | (2) | 84 |
| Example 3 | | | | | | | | | | | |
| Example 18 | (1) | 40 | (1) | 80 | (1) | PAR(1) | A1-3 | B1-4 | 120 | (3) | 85 |
| Example 19 | (1) | 40 | (1) | 80 | (1) | PAR(1) | A1-3 | B1-4 | 120 | (4) | 95 |
| Comparative | (1) | 40 | (1) | 80 | (1) | PAR(1) | A1-3 | B1-4 | 120 | (5) | 96 |
| Example 4 | | | | | | | | | | | |
| Comparative | (1) | 40 | (1) | 80 | (1) | PAR(1) | A1-3 | B1-4 | 120 | (6) | 90 |
| Example 5 | | | | | | | | | | | |
| Example 20 | (1) | 40 | (1) | 80 | (1) | PAR(1) | A1-3 | B1-4 | 120 | (7) | 90 |
| Example 21 | (1) | 40 | (1) | 80 | (1) | PAR(1) | A1-3 | B1-4 | 120 | (8) | 90 |
| Comparative | (1) | 40 | (1) | 80 | (1) | PAR(1) | A1-3 | B1-4 | 120 | (9) | 90 |
| Example 6 | | | | | | | | | | | |
| Example 22 | (1) | 40 | (1) | 80 | (1) | PAR(1) | A1-3 | B1-4 | 120 | (10) | 87 |
| Example 23 | (1) | 40 | (1) | 80 | (1) | PAR(1) | A1-3 | B1-4 | 120 | (1) | 90 |
| Example 24 | (1) | 40 | (1) | 80 | (1) | PAR(1) | A1-3 | B1-4 | 120 | (1) | 90 |

| | Cleaning blade | | | | Performance evaluation | | | |
|---|---|---|---|---|---|---|---|---|
| | Second | | tanδ(Max) − | Pressing | | | Density | |
| | PU layer | tanδ(Max) | tanδ(Min) | pressure | Blurring | Fogging | unevenness | Filming |
| | Hardness | — | — | gf/mm | — | — | — | — |
| Comparative | 65 | 0.42 | 0.04 | 2 | D | G5 | C | G3 |
| Example 1 | | | | | | | | |
| Comparative | 65 | 0.42 | 0.04 | 2 | A | G1 | D | G3 |
| Example 2 | | | | | | | | |
| Example 1 | 65 | 0.42 | 0.04 | 2 | A | G1 | A | G1 |
| Example 2 | 65 | 0.42 | 0.04 | 2 | C | G3 | C | G2 |
| Example 3 | 65 | 0.42 | 0.04 | 2 | B | G3 | B | G2 |
| Example 4 | 65 | 0.42 | 0.04 | 2 | B | G2 | B | G2 |
| Example 5 | 65 | 0.42 | 0.04 | 2 | B | G3 | C | G2 |
| Example 6 | 65 | 0.42 | 0.04 | 2 | B | G3 | B | G1 |
| Example 7 | 65 | 0.42 | 0.04 | 2 | B | G3 | C | G1 |
| Example 8 | 65 | 0.42 | 0.04 | 2 | B | G2 | B | G1 |
| Example 9 | 65 | 0.42 | 0.04 | 2 | B | G2 | B | G1 |
| Example 10 | 65 | 0.42 | 0.04 | 2 | C | G3 | C | G1 |
| Example 11 | 65 | 0.42 | 0.04 | 2 | A | G1 | A | G1 |
| Example 12 | 65 | 0.42 | 0.04 | 2 | A | G1 | A | G1 |
| Example 13 | 65 | 0.42 | 0.04 | 2 | A | G1 | A | G1 |
| Example 14 | 65 | 0.42 | 0.04 | 2 | A | G1 | A | G1 |
| Example 15 | 65 | 0.42 | 0.04 | 2 | A | G1 | A | G1 |
| Example 16 | 65 | 0.42 | 0.04 | 2 | A | G1 | B | G2 |
| Example 17 | 65 | 0.42 | 0.04 | 2 | A | G1 | C | G3 |
| Comparative | 65 | 0.51 | 0.11 | 2 | A | G2 | C | G4 |
| Example 3 | | | | | | | | |
| Example 18 | 65 | 0.49 | 0.10 | 2 | A | G1 | B | G3 |
| Example 19 | 65 | 0.38 | 0.09 | 2 | A | G1 | C | G1 |
| Comparative | 65 | 0.35 | 0.13 | 2 | A | G1 | D | G2 |
| Example 4 | | | | | | | | |
| Comparative | 53 | 0.53 | 0.15 | 2 | B | G4 | C | G4 |
| Example 5 | | | | | | | | |
| Example 20 | 55 | 0.48 | 0.07 | 2 | C | G2 | B | G2 |
| Example 21 | 70 | 0.38 | 0.06 | 2 | B | G1 | C | G2 |
| Comparative | 72 | 0.40 | 0.14 | 2 | B | G1 | D | G3 |
| Example 6 | | | | | | | | |
| Example 22 | 58 | 0.51 | 0.13 | 2 | A | G1 | B | G3 |
| Example 23 | 65 | 0.42 | 0.04 | 1 | A | G1 | B | G3 |
| Example 24 | 65 | 0.42 | 0.04 | 4 | A | G1 | C | G2 |

Meanings of the abbreviations in Table 6 are as follows.
First PU layer: first polyurethane layer—Second PU layer: second polyurethane layer-PAR: polyarylate resin—PC: polycarbonate resin

The image forming apparatus according to the present disclosure includes the following aspects. Each formula is the same as the formula having the same number described above.

### Supplementary Notes

(((1)))

An image forming apparatus comprising:
a photoreceptor;
a charging device that charges a surface of the photoreceptor;
an electrostatic latent image forming device that forms an electrostatic latent image on the charged surface of the photoreceptor;
a developing device that contains a developer containing a toner and develops the electrostatic latent image formed on the surface of the photoreceptor to form a toner image;
a transfer device that transfers the toner image to a surface of a recording medium; and
a cleaning device that has a cleaning blade coming into contact with the surface of the photoreceptor to clean the surface of the photoreceptor,
wherein the toner contains toner particles, titanate compound particles, and silica particles,
a surface layer of the photoreceptor contains a polyarylate resin that has a dicarboxylic acid unit (A) represented by Formula (A) and a diol unit (B) represented by Formula (B), and
the cleaning blade has a first polyurethane layer that is a layer coming into contact with the photoreceptor and has a hardness of 85 degrees or more and 95 degrees or less, and a second polyurethane layer that is a layer supporting the first polyurethane layer and has a hardness of 55 degrees or more and 70 degrees or less.
   (((2)))

The image forming apparatus according to (((1))),
wherein, in a dynamic viscoelasticity measurement of the cleaning blade, in a case where a maximum value of a loss tangent in a range of 0° C. or higher and 30° C. or lower is defined as tanδ(Max) and a minimum value of the loss tangent is defined as tanδ(Min), tanδ(Max)≤0.5 and tanδ(Max)−tanδ(Min)≤0.1 are satisfied.
   (((3)))

The image forming apparatus according to (((1))) or (((2))),
wherein the photoreceptor has a charge generation layer and a charge transport layer, and the charge transport layer is the surface layer.
   (((4)))

The image forming apparatus according to any one of (((1))) to (((3))),
wherein a weight-average molecular weight of the polyarylate resin contained in the surface layer of the photoreceptor is 80,000 or more and 150,000 or less.
   (((5)))

The image forming apparatus according to any one of (((1))) to (((4))),
wherein an average primary particle size of the titanate compound particles contained in the toner is 20 nm or more and 100 nm or less.
   (((6)))

The image forming apparatus according to any one of (((1))) to (((5))),
wherein an average primary particle size of the silica particles contained in the toner is 50 nm or more and 150 nm or less.
   (((7)))

The image forming apparatus according to any one of (((1))) to (((6))),
wherein the titanate compound particles include alkali earth metal titanate particles.
   (((8)))

The image forming apparatus according to any one of (((1))) to (((7))),
wherein the titanate compound particles include strontium titanate particles containing a dopant.
   (((9)))

The image forming apparatus according to (((8))),
wherein the dopant includes lanthanum.
   (((10)))

The image forming apparatus according to any one of (((1))) to (((9))),
wherein the cleaning blade comes into contact with the surface of the photoreceptor with a pressing pressure of 1 gf/mm or more and 4 gf/mm or less.
   (((11)))

The image forming apparatus according to any one of (((1))) to (((10))),
wherein the dicarboxylic acid unit (A) includes at least one selected from the group consisting of a dicarboxylic acid unit (A1) represented by Formula (A1), a dicarboxylic acid unit (A2) represented by Formula (A2), and a dicarboxylic acid unit (A3) represented by Formula (A3).
   (((12)))

The image forming apparatus according to any one of (((1))) to (((11))),
wherein the diol unit (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a photoreceptor;
a charging device that charges a surface of the photoreceptor;
an electrostatic latent image forming device that forms an electrostatic latent image on the charged surface of the photoreceptor;
a developing device that contains a developer containing a toner and develops the electrostatic latent image formed on the surface of the photoreceptor to form a toner image;
a transfer device that transfers the toner image to a surface of a recording medium; and
a cleaning device that has a cleaning blade coming into contact with the surface of the photoreceptor to clean the surface of the photoreceptor,
wherein the toner contains toner particles, titanate compound particles, and silica particles,
a surface layer of the photoreceptor contains a polyarylate resin that has a dicarboxylic acid unit (A) represented by Formula (A) and a diol unit (B) represented by Formula (B), and
the cleaning blade has a first polyurethane layer that is a layer coming into contact with the photoreceptor and has a hardness of 85 degrees or more and 95 degrees or less, and a second polyurethane layer that is a layer supporting the first polyurethane layer and has a hardness of 55 degrees or more and 70 degrees or less, 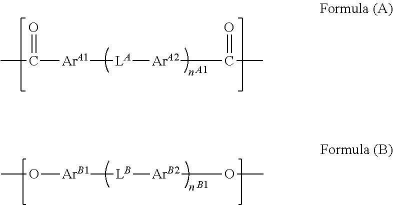
in Formula (A), Ar^{A1} and Ar^{A2} are each independently an aromatic ring which may have a substituent, L^{A} is a single bond or a divalent linking group, and n^{A1} is 0, 1, or 2,
in Formula (B), Ar^{B1} and Ar^{B2} are each independently an aromatic ring which may have a substituent, L^{B} is a single bond, an oxygen atom, a sulfur atom, or —C(Rb¹)(Rb²)—, and n^{B1} is 0, 1, or 2, where Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

2. The image forming apparatus according to claim 1,
wherein, in a dynamic viscoelasticity measurement of the cleaning blade, in a case where a maximum value of a loss tangent in a range of 0° C. or higher and 30° C. or lower is defined as tanδ(Max) and a minimum value of the loss tangent is defined as tanδ(Min), tanδ(Max)≤0.5 and tanδ(Max)−tanδ(Min)≤0.1 are satisfied.

3. The image forming apparatus according to claim 1,
wherein the photoreceptor has a charge generation layer and a charge transport layer, and the charge transport layer is the surface layer.

4. The image forming apparatus according to claim 1,
wherein a weight-average molecular weight of the polyarylate resin contained in the surface layer of the photoreceptor is 80,000 or more and 150,000 or less.

5. The image forming apparatus according to claim 1,
wherein an average primary particle size of the titanate compound particles contained in the toner is 20 nm or more and 100 nm or less.

6. The image forming apparatus according to claim 1,
wherein an average primary particle size of the silica particles contained in the toner is 50 nm or more and 150 nm or less.

7. The image forming apparatus according to claim 1,
wherein the titanate compound particles include alkali earth metal titanate particles.

8. The image forming apparatus according to claim 1,
wherein the titanate compound particles include strontium titanate particles containing a dopant.

9. The image forming apparatus according to claim 8,
wherein the dopant includes lanthanum.

10. The image forming apparatus according to claim 1,
wherein the cleaning blade comes into contact with the surface of the photoreceptor with a pressing pressure of 1 gf/mm or more and 4 gf/mm or less.

11. The image forming apparatus according to claim 1,
wherein the dicarboxylic acid unit (A) includes at least one selected from the group consisting of a dicarboxylic acid unit (A1) represented by Formula (A1), a dicarboxylic acid unit (A2) represented by Formula (A2), and a dicarboxylic acid unit (A3) represented by Formula (A3), 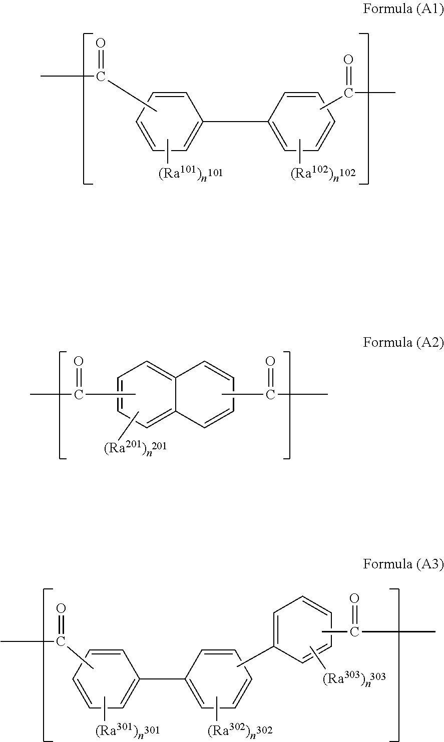
in Formula (A1), n¹⁰¹ and n¹⁰² are each independently an integer of 0 or more and 4 or less, and n¹⁰¹ pieces of Ra¹⁰¹'s and n¹⁰² pieces of Ra¹⁰²'s are each independently an alkyl group having 1 or more and 10 or less carbon atoms, an aryl group having 6 or more and 12 or less carbon atoms, or an alkoxy group having 1 or more and 6 or less carbon atoms,
in Formula (A2), n²⁰¹ is an integer of 0 or more and 6 or less, and n²⁰¹ pieces of Ra²⁰¹'s are each independently an alkyl group having 1 or more and 10 or less carbon atoms, an aryl group having 6 or more and 12 or less carbon atoms, or an alkoxy group having 1 or more and 6 or less carbon atoms,
in Formula (A3), n³⁰¹, n³⁰², and n³⁰³ are each independently an integer of 0 or more and 4 or less, and n³⁰¹ pieces of Ra³⁰¹'s, n³⁰² pieces of Ra³⁰²'s, and n³⁰³ pieces of Ra³⁰³'s are each independently an alkyl group having 1 or more and 10 or less carbon atoms, an aryl group having 6 or more and 12 or less carbon atoms, or an alkoxy group having 1 or more and 6 or less carbon atoms.

12. The image forming apparatus according to claim 1,
wherein the diol unit (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8), 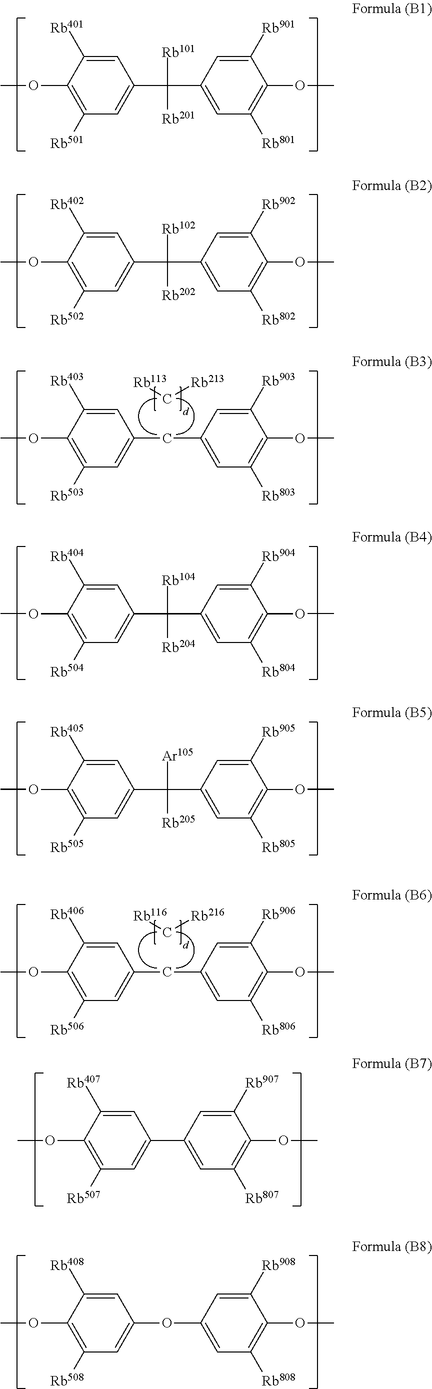
in Formula (B1), Rb¹⁰¹ is a branched alkyl group having 4 or more and 20 or less carbon atoms, Rb²⁰¹ is a hydrogen atom or an alkyl group having 1 or more and 3 or less carbon atoms, and Rb⁴⁰¹, Rb⁵⁰¹, Rb⁸⁰¹, and Rb⁹⁰¹ are each independently a hydrogen atom, an alkyl group having 1 or more and 4 or less carbon atoms, an alkoxy group having 1 or more and 6 or less carbon atoms, or a halogen atom,
in Formula (B2), Rb¹⁰² is a linear alkyl group having 4 or more and 20 or less carbon atoms, Rb²⁰² is a hydrogen atom or an alkyl group having 1 or more and 3 or less carbon atoms, and Rb⁴⁰², Rb⁵⁰², Rb⁸⁰², and Rb⁹⁰² are each independently a hydrogen atom, an alkyl group having 1 or more and 4 or less carbon atoms, an alkoxy group having 1 or more and 6 or less carbon atoms, or a halogen atom,
in Formula (B3), Rb¹¹³ and Rb²¹³ are each independently a hydrogen atom, a linear alkyl group having 1 or more and 3 or less carbon atoms, an alkoxy group having 1 or more and 4 or less carbon atoms, or a halogen atom, d is an integer of 7 or more and 15 or less, and Rb⁴⁰³, Rb⁵⁰³, Rb⁸⁰³, and Rb⁹⁰³ are each independently a hydrogen atom, an alkyl group having 1 or more and 4 or less carbon atoms, an alkoxy group having 1 or more and 6 or less carbon atoms, or a halogen atom,
in Formula (B4), Rb¹⁰⁴ and Rb²⁰⁴ are each independently a hydrogen atom or an alkyl group having 1 or more and 3 or less carbon atoms, and Rb⁴⁰⁴, Rb⁵⁰⁴, Rb⁸⁰⁴, and Rb⁹⁰⁴ are each independently a hydrogen atom, an alkyl group having 1 or more and 4 or less carbon atoms, an alkoxy group having 1 or more and 6 or less carbon atoms, or a halogen atom,
in Formula (B5), Ar¹⁰⁵ is an aryl group having 6 or more and 12 or less carbon atoms or an aralkyl group having 7 or more and 20 or less carbon atoms, Rb²⁰⁵ is a hydrogen atom or an alkyl group having 1 or more and 3 or less carbon atoms, and Rb⁴⁰⁵, Rb⁵⁰⁵, Rb⁸⁰⁵, and Rb⁹⁰⁵ are each independently a hydrogen atom, an alkyl group having 1 or more and 4 or less carbon atoms, an alkoxy group having 1 or more and 6 or less carbon atoms, or a halogen atom,
in Formula (B6), Rb¹¹⁶ and Rb²¹⁶ are each independently a hydrogen atom, a linear alkyl group having 1 or more and 3 or less carbon atoms, an alkoxy group having 1 or more and 4 or less carbon atoms, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, an alkyl group having 1 or more and 4 or less carbon atoms, an alkoxy group having 1 or more and 6 or less carbon atoms, or a halogen atom,
in Formula (B7), Rb⁴⁰⁷, Rb⁵⁰⁷, Rb⁸⁰⁷, and Rb⁹⁰⁷ are each independently a hydrogen atom, an alkyl group having 1 or more and 4 or less carbon atoms, an alkoxy group having 1 or more and 6 or less carbon atoms, or a halogen atom,
in Formula (B8), Rb⁴⁰⁸, Rb⁵⁰⁸, Rb⁸⁰⁸, and Rb⁹⁰⁸ are each independently a hydrogen atom, an alkyl group having 1 or more and 4 or less carbon atoms, an alkoxy group having 1 or more and 6 or less carbon atoms, or a halogen atom.
